(19) United States
(12) Patent Application Publication
(10) Pub. No.: US 2012/0090825 A1
(43) Pub. Date: Apr. 19, 2012

(54) NANOFIBER COVERED MICRO COMPONENTS AND METHODS FOR MICRO COMPONENT COOLING

(75) Inventors: Alexander L. Yarin, Clarendon Hills, IL (US); Srikar Raman, Delhi (IN); Tatiana Gambaryan-Roisman, Darmstadt (DE); Suman Sinha Ray, Chicago, IL (US); Yiyun Zhang, Chicago, IL (US)

(73) Assignee: THE BOARD OF TRUSTEES OF THE UNIVERSITY OF ILLINOIS, Urbana, IL (US)

(21) Appl. No.: 13/273,719

(22) Filed: Oct. 14, 2011

Related U.S. Application Data
(63) Continuation-in-part of application No. PCT/US2010/036921, filed on Jun. 1, 2010.
(60) Provisional application No. 61/182,878, filed on Jun. 1, 2009.
(60) Provisional application No. 61/393,690, filed on Oct. 15, 2010.

(51) Int. Cl. F28F 7/00; C25D 7/12; B82Y 30/00; B82Y 40/00

(52) U.S. Cl. 165/185; 205/157; 977/784; 977/890

(57) ABSTRACT

A device including a micro component having an external surface and a permeable nanofiber covering on at least a portion of the external surface of the micro component. A cooled micro component system further includes a droplet spray system for spraying liquid droplets onto the nanofiber covering to cool the micro component. In an example method for cooling a micro component, droplet spray is directed onto a nanofiber covering that covers at least a portion of the micro component. The directing is controlled to permit efficient spreading and evaporation of liquid permeating the nanofiber covering. In example embodiments nanofibers of the permeable nanofiber covering are metalized to provide a rougher surface (e.g., a nano-textured metal layer).

### PRIORITY CLAIM

This application is a continuation-in-part of International Application Number PCT/US2010/036921, filed Jun. 1, 2010, which claims priority to U.S. Provisional Application Ser. No. 61/182,878, filed Jun. 1, 2009. This application also claims priority to U.S. Provisional Application Ser. No. 61/393,690, filed Oct. 15, 2010, which is incorporated by reference herein.

### STATEMENT OF GOVERNMENT INTEREST

This invention was made with Government support under Grant No. CBET 0966764 awarded by National Science Foundation (NSF) and Grant No. NNX10AR99G awarded by National Aeronautics and Space Administration (NASA). The Government has certain rights in the invention.

### FIELD OF THE INVENTION

This application relates generally to the field of microelectronics and optoelectronics. More particular embodiments relate to cooling of microelectronic and optoelectronic components.

### BACKGROUND OF THE INVENTION

Miniaturization and breakthrough developments of multiple micro components, such as but not limited to semiconductor, optical, and radiological micro components, and micro components for robotic devices such as Unmanned Aerial Vehicles and Unmanned Ground Vehicles (UAVs and UGVs, respectively) are severely hindered by the requirement of cooling such devices at high heat fluxes. As just one example, carrying electro-optical, infra-red and other sensors, video equipment, targeting systems, and running signal intelligence systems or real-time image processing promotes a strong appetite of UAVs for greater power densities on board. Nonlimiting example high heat fluxes for micro components are of the order of 1 kW/cm².

Many active and passive cooling strategies have been attempted to cool these micro components. Example strategies that have been attempted, some without practical success, include conduction, heat spreading, air cooling, piezo fans, synthetic jet cooling, nanolightning, liquid jet cooling (including liquid metal jets), heat pipes, cold plates, immersion cooling, micro-channel heat sinks, and drop and spray cooling. Drop and spray cooling, for many micro components, may provide a desirable, and in some cases the only possible, remedy for cooling.

Spray cooling, which uses the evaporation of liquid to achieve cooling, can be highly effective, but its efficiency is limited by a number of factors. One such limiting factor is that the receding motion of spread liquid lamellae on hot metal and silicon surfaces of microelectronic components leads in many cases to complete bouncing and interruption of cooling. Another limiting factor is the Leidenfrost effect, which is the levitation of drops over the surface caused by extremely fast evaporation. Such levitation limits the beneficial effect of contact cooling. Work in the art on the spray cooling of particular micro components, such as microelectronic components (e.g., processors), has focused on precision delivery of spray.

### SUMMARY OF THE INVENTION

Embodiments of the present invention provide, among other things, a device including a micro component having an external surface and a permeable nanofiber covering on at least a portion of the external surface of the micro component. The nanofiber covering provides a nano-textured layer for receiving a cooling liquid that improves efficiency of drop and spray cooling of the micro component. A cooled micro component system includes the device including the micro component and the nanofiber covering, and a droplet spray system for spraying liquid droplets onto the nanofiber covering to cool the micro component.

In an example method for cooling a micro component, droplet spray is directed onto a permeable nanofiber covering that covers at least a portion of the micro component. The directing is controlled to permit efficient spreading and evaporation of liquid permeating the nanofiber covering.

In some example embodiments of the present invention, the nanofiber covering is metalized to provide a rougher nano-textured metal layer, thus providing a rougher-textured nanofiber mat. For example, the nanofiber covering may be electroplated with any of various methods. An example fabrication method for metalized nanofiber coverings comprises providing a non-woven polymer mat, sensitizing the non-woven polymer mat to make the mat conductive or semi-conductive, such as by forming a conductive coating on the mat, and electroplating the sensitized mat with a selected metal. The metalized nanofiber covering can be used in a similar manner as other (non-metalized) nanofiber coverings for cooling micro components.

### BRIEF DESCRIPTION OF THE DRAWINGS

FIG. 1 is a perspective view of a device including a micro component and a permeable nanofiber covering, according to an embodiment of the present invention;

FIG. 2 is a side elevation view of the device of FIG. 1;

FIG. 3 is a side elevation view of a micro component cooling system including the device of FIG. 1, according to an embodiment of the present invention;

FIGS. 4A-4C show images of drops deposited on unheated stripes covered with PAN nanomats, where FIG. 4A is immediately after a soft deposition, FIG. 4B is 10 min after deposition, and FIG. 4C is 17 min after deposition;

FIG. 5 shows two drops deposited on an uncovered steel stripe;

FIG. 6 shows a drop deposited on a steel stripe covered with wettability promoter;

FIGS. 7A-7C show results of heat transfer experiments after a drop deposition, where FIG. 7A is after a gentle drop deposition, FIG. 7B is after a drop falling down from a 10 cm height, and FIG. 7C is after a drop falling down from a 15 cm height;

FIG. 8 shows data for masses of polymer nanofiber mats at room temperature and after 15 min heat treatment at different temperatures for 1) PAN, 2) PCL, 3) PCL-CB, 4) PMMA, and 5) PU;

FIG. 9 shows thermograms for PCL nanofiber mats and pellets, including 1) PCL nanofiber mat electrospun from 11% PCL solution; 2) PCL pellet, and 3) electrospun PCL-CB nanocomposite nanofiber mat;

FIGS. 10A-10D show junctions of individual nanofibers on a glass slide at different temperatures, where FIG. 10A is at 36.5° C., FIG. 10B is at 49.3° C., FIG. 10C is at 53.55° C., and FIG. 10D is at 59.9° C.;

FIGS. 11A-F shows optical images of PCL nanofiber mats during heat treatment at various temperatures;

FIG. 12 shows DSC thermograms for 1) PMMA nanofiber mats electrospun from 11% and 2) PMMA powder;

FIGS. 13A-13D show optical images of junctions of PMMA nanofibers at different temperatures, where FIG. 13A is for 33.3° C., FIG. 13B is for 50.9° C., FIG. 13C is for 90.7° C., and FIG. 13D is for 125.7° C.;

FIGS. 14A-14F show optical images of PMMA nanofiber mats during heating at various temperatures;

FIG. 15 shows DSC thermograms for PAN, including 1) PAN nanofibers electrospun from 12% solution, and 2) PAN powder;

FIGS. 16A-16D show optical images of junctions of individual PMMA nanofibers at different temperatures, where FIG. 16A is for 35.3° C., FIG. 16B is for 68.1° C., FIG. 16C is for 90.1° C., and FIG. 16D is for 125.0° C.;

FIG. 17 shows DSC thermograms for PU;

FIGS. 18A-18D show optical images of junctions of individual PU nanofibers at different temperatures, where FIG. 18A is for 26.7° C., FIG. 18B is for 40.8° C., FIG. 18C is for 53.8° C., and FIG. 18D is for 87.5° C.;

FIGS. 19A-19F show optical images of PU nanofiber mats subjected to heat treatment at various temperatures;

FIGS. 20A-20B show a top view of a PAN nanomat, and a drop deposited softly on a partially wettable PAN nanomat, respectively;

FIGS. 21A-21B show two variations of an experimental setup, where FIG. 21A shows a syringe drop generator used for direct impacts of 2-3 drops or a commercial piezoelectric drop-on-demand device (Microdrop) was used to generate drops of approximately 100 μm, and FIG. 21B shows a syringe drop generator producing primary drops;

FIGS. 22A-22D show optical images of different modes of drop impact on a PAN nanomat, where FIG. 22A shows deposition, FIG. 22B shows fingering without splash, FIG. 22C shows receding splash, and FIG. 22D shows advancing splash, and where the time span is 1.5 ms, the drop diameter is 2 mm, and the impact speed is 1.7 m/s, 2 m/s, 2.3 m/s, and 2.7 m/s;

FIG. 23 shows impact of a 2 mm drop with 1.5 m/s onto a) a dry PAN nanomat; b) onto a wet saturated PAN nanomat, c) onto a wet PAN nanomat with a 100 μm water film on it, and d) onto pure uncoated copper with a 100 μm water film on it;

FIGS. 24A-24B shows outcomes of drop impact onto PAN nanomats at various parameters near the splashing threshold (K_{ds}=87), where FIG. 24A shows deposition without fingers and advancing splash, and FIG. 24B shows fingering and receding splash;

FIG. 25 shows a probability chart for different impact outcomes as a function of K_{d};

FIG. 26 shows an experimental setup with conditioned air to control humidity;

FIGS. 27A-27C show water spreading inside a PAN nanomat, where FIG. 27A shows images with wetted spot configurations at different time moments (t=0 s corresponds to the moment when water in the drop deposited onto nanomat has come to rest), FIG. 27B shows contours of the wetted spot inside the nanomat at different time moments (images taken for a time interval below 6 s), and FIG. 27C shows close-to-circular contours of a wetted spot;

FIGS. 28A-28C show wetted area in PAN nanomat versus time, where the locus of minimum values (the slowest front propagation in ten experiments) is plotted as dotted lines, as well as the locus of the maximum values (the fastest propagation recorded in ten experiments), and where the average values for ten measurements at a fixed humidity level are plotted in solid lines for 7% humidity (FIG. 28A), 81% humidity (FIG. 28B) and several humidity values (7%, 18%, 31%, 44%, 56% 68%, and 81%) together (FIG. 28B);

FIG. 29 shows maximum spreading area in a PAN nanomat as a function of the time to maximum spreading;

FIG. 30 shows a method for electroplating nanofiber mats to provide metalized nanofiber mats having increased surface roughness, according to another embodiment of the invention;

FIG. 31 shows an experimental setup for investigating drop impacts on metalized nanofiber mats;

FIGS. 32A-32D are SEM images of copper-plated fibers according to an embodiment of the present invention, where FIG. 32A shows an overall view of a copper-plated fiber mat, FIG. 32B shows a zoomed-in view of a top layer, FIG. 32C shows individual thorny nano-textured fibers at a location on the mat, and FIG. 32D shows individual grainy nano-textured fibers;

FIGS. 33A-33D are SEM images of dendrite-like and cactus-like silver-plated nanofiber mats, where FIGS. 33A-33B show an overall view of the nanofiber mat at two respective locations, and FIGS. 33C-33D show respective detailed views of cactus-like nanofibers;

FIGS. 34A-34D are SEM images of nickel-plated nanofibers, where FIGS. 34A-34B show an overall view of nickel-plated nanofibers at two respective locations, FIG. 34C shows smooth nano-texture of individual nickel-plated nanofibers (coating broken at some places due to exposing of skeletal template polymer), and FIG. 34D shows rough nanotexture of individual nickel-plated nanofibers;

FIGS. 35A-35D are SEM images of gold-plated nanofibers, where FIG. 35A shows an overall view of a gold-plated nanofiber mat, FIG. 35B shows a zoomed-in view of upper layers with visible appendices scattered over the fibers, and FIGS. 35C-35D show individual fibers, including almost smooth coatings with some appendices at two different respective locations;

FIGS. 36A-36D are SEM images of a cut copper-plated nanofiber mat, where FIG. 36A shows an overall view of the mat, FIG. 36B shows an enlarged area (circled in FIG. 36A), and FIGS. 36C-36D show detailed structures of the copper-plated fiber mat near the substrate at two respective locations;

FIG. 37 shows dependence of drop evaporation time on a metal-plated nanofiber mat on ΔT at the room temperature of 20° C., where the slope is equal to 31 0.9976 in log-log coordinates, where from the equation the slope −1 is anticipated, and the coefficient of determination R²=0.9128;

FIGS. 38A-38C show drop impact from a height of 3.55 cm

$$( {V}_{0} = 83.46 \frac{cm}{s} )$$

onto a copper-plated nanofiber mat at 150° C. (display temperature corresponding to 125.6° C. of the sample) at 0 ms—at the moment of impact (FIG. 38A), at 32.5 ms (FIG. 38B), and at 66 ms (FIG. 38C);

FIGS. 39A-39C show a top view of drop impact onto a copper-plated nanofiber mat as shown in FIGS. 38A-38C at t=0 ms (FIG. 39A), −33 ms (the closest to 32.5 ms the ordinary CCD could resolve) (FIG. 39B), and −66 ms (FIG. 39C);

FIG. 40 shows drop impact onto example thorny nanofibers at 125° C. (the display temperature corresponding to 102.7° C. of the samples) at 0 ms, 33 ms, 66 ms, and 132 ms (rows a)-d), respectively), for (columns from left to right) copper-plated fibers, a bare copper substrate, silver-plated fibers, nickel-plated fibers, and gold-plated fibers, respectively;

FIG. 41 shows drop impact onto example thorny nanofibers at 150° C. (the display temperature corresponding to 125.6° C. of the samples) at 0 ms, 33 ms, 66 ms, and 132 ms (rows a)-d), respectively), for (columns from left to right) copper-plated fibers, a bare copper substrate, silver-plated fibers, nickel-plated fibers, and gold-plated fibers, respectively;

FIG. 42 shows drop impact onto example thorny nanofibers at 200° C. (the display temperature corresponding to 172.2° C. of the samples) at 0 ms, 33 ms, 66 ms, and 132 ms (rows a)-d), respectively), for (columns from left to right) copper-plated fibers, a bare copper substrate, silver-plated fibers, nickel-plated fibers, and gold-plated fibers, respectively;

FIGS. 43A-43C show mass losses due to “atomization” during cooling through copper plated nanofiber mats at 125° C. (FIG. 43A), 150° C. (FIG. 43B), and 200° C. (FIG. 43C) (the display temperatures corresponding to 102.7° C., 125.6° C., and 172.2° C. of the samples, respectively);

FIG. 44 shows mass losses due to “atomization” during cooling of a bare copper substrate at 125° C. (the display temperature corresponding to 102.7° C. of the sample);

FIGS. 45A-45B show mass losses due to “atomization” during cooling through silver-plated nanofiber mats at 150° C. (FIG. 45A) and 200° C. (FIG. 45B) (the display temperature corresponding to 125.6° C. and 172.2° C. of the sample, respectively); and

FIGS. 46A-46C show mass losses due to “atomization” during cooling through nickel-plated nanofiber mats at 125° C. (FIG. 46A), 150° C. (FIG. 46B), and 200° C. (FIG. 46C) (the display temperature corresponding to 102.7° C., 125.6° C., and 172.2° C. of the sample, respectively).

### DETAILED DESCRIPTION

Embodiments of the present invention provide, among other things, nanofiber covered micro components, and methods for cooling micro components. A nonlimiting example of a micro component as used herein is a microelectronic component, such as but not limited to microprocessors, amplifiers, and memory components. Preferred embodiments of the invention include droplet and spray cooling systems having micro components at least partially covered with nanofiber materials.

An example device according to embodiments of the present invention includes a micro component having an external surface, and a nano-textured layer embodied in a permeable nanofiber covering on at least a portion of the external surface. The micro component may be, as nonlimiting examples, a microelectronic component (such as, but not limited to, a microprocessor), a radiological micro component, or an optoelectronic component. Generally, a micro component refers to any article that is used separately or represents a part of any bigger device (or construction, e.g., of a server room wall), which releases heat and should be cooled by spray cooling or individual drop cooling. This micro component's external surface preferably is a high heat flux surface, which as a nonlimiting example has a heat flux of at least 1 kW/cm². It is to be understood, however, that devices and methods according to the present invention may be used to cool devices having higher or lower heat fluxes.

The nanofiber covering providing the nano-textured layer may be made from a polymer material, though non-polymer materials can also be used. A particular example covering can be made from an electrospinnable polymer having a thermal stability within an operational temperature range of the micro component. For example, the polymer or non-polymer nanofiber covering material should have a melting point that is higher than the operational range of the microelectronic component. Typically, this suggests a melting point higher than about 100° C., though other melting points are possible. With such thermal stability, heat from the micro component does not result in significant loss of nanofiber material. Nonlimiting examples of polymer that may be used are described below, though selected polymers (or non-polymer material) may vary depending on, for instance, the micro component being cooled. Preferably, the material is a polymer that is either partially wettable or non-wettable.

A nonlimiting example nanofiber covering is a non-woven polymer nanofiber covering. Non-woven nanofiber coverings can efficiently promote the spreading and then permeation of liquid. Patterned nanofiber coverings may alternatively or additionally be used, but these may be less efficient for cooling. A more particular example non-woven nanofiber covering is a nanofiber mat. Certain example embodiments also metalize the nanofiber mat to provide a rougher surface.

In some example embodiments, the nanofiber covering is metalized to provide a rougher nano-textured metal layer, and thus providing a rougher-textured nanofiber mat. For example, the nanofiber covering may be electroplated with any of various methods. In an example fabrication method for metalized nanofiber coverings, a non-woven polymer mat is provided and is sensitized to make the mat conductive or semi-conductive. The sensitized mat is electroplated with a selected metal. The metalized nanofiber covering can be used in a similar manner as other (non-metalized) nanofiber coverings for cooling micro components.

In example embodiments, the nanofiber material is selected to adhere to the micro component. Alternatively, an adhesion layer is used to adhere the nanofiber material to the micro component so that it forms a coating. Thus, “covering” may refer to directly or indirectly covering the surface of the micro component. Further, “covering” does not require complete covering of a micro component surface, but rather refers to a position relative to the micro component surface so that the nanofiber covering can receive a liquid droplet and deliver at least part of the liquid droplet to the micro component surface. In embodiments where the nanofiber covering is metalized, the metallization process may result in adhesion with a surface to be cooled.

A cooled microelectronic system according to embodiments of the present invention includes a micro component and nanofiber covering as provided above, and a droplet spray system for spraying liquid droplets onto the nanofiber covering to cool the micro component. A nonlimiting example droplet spray system includes a liquid source, at least one liquid passage in fluid communication with the liquid source, and a fluid pressure source in fluid communication with the liquid source and at least one liquid passage. The fluid pressure source may be selectively controlled by a suitably coupled controller for controlled delivery of liquid droplets to the nanofiber covering. Example liquids include water and any other refrigerant that remains liquid down to −60° C. The at least one liquid passage may include a plurality of passages coupled to a manifold, where the manifold is in fluid communication with the pressure source and the plurality of passages. In this way, an example droplet spray system can spray droplets of the selected liquid onto the nanofiber covering to cool the micro component. A chamber may be provided for housing the micro component and nanofiber covering, where the at least one liquid passage is in fluid communication with the chamber interior.

In an example cooling method, a nanofiber covering is provided, and a surface of a micro component is covered (fully or partially) with the nanofiber material. At least one liquid droplet is directed onto the nanofiber covering, which cools the micro component surface. This directing is controlled to permit efficient spreading and evaporation of liquid permeating the nanofiber covering. An example nanofiber material covering according to this method provides a nano-textured layer that efficiently accepts individual droplets or sprays to reduce or eliminate receding or bouncing back, as happens in spray cooling of uncovered metal, polymer, and silicon surfaces, and then efficiently spreads the droplets or sprays, which penetrate the nanofiber to increase wetting of the underlying micro component. Therefore, such drops inside nanofiber mats are fully evaporated in close contact with the warm substrate and remove significant amounts of heat due to very high latent heat of water evaporation. This creates a more efficient cooling mechanism versus a droplet or spray directed at a micro component lacking the covering.

A nanofiber covering provided according to an example method is a non-woven polymeric covering, such as a nanofiber mat, providing a nano-textured layer. An example nanofiber mat is a porous permeable material composed of individual non-woven polymer nanofibers, which are randomly oriented in the mat plane. This example non-woven polymeric covering can be provided by providing (e.g., selecting and/or preparing) a polymer, and electrospinning or otherwise depositing the polymer onto a surface. Though electrospun polymers are preferred, non-polymer coverings that can withstand electrospinning (or other suitable deposition) and form solids can also be used. In a nonlimiting example embodiment, the polymer is electrospun onto the surface of the micro component to provide a convenient deposition, though alternatively the polymer may be electrospun onto a different surface and then transferred (with or without an adhesive layer) to the surface of the micro component. The electrospun polymer can be sensitized to be conductive or semi-conductive and metalized (e.g., electroplated) to increase surface roughness of the electrospun polymer.

A nonlimiting example method of drop and spray cooling of micro components, such as microelectronic components, radiological, optoelectronic, or robotic components, covers a high-heat flux surface of the micro component with electrospun non-woven polymer nanofiber material. The example nanofiber material thickness is sufficiently permeable for liquid (e.g., water) droplets, which are delivered individually or in spray to the surface of the component. In operation, partial wettability of the nanofiber covering allows water to reach the hot micro component surface. The enhanced cooling efficiency in the presence of such electrospun material results from the material's capability to partially or fully eliminate the receding and bouncing of the spray drops that are characteristic of conventional spray cooling methods.

Liquid (such as, but not limited to, water) droplets thus are spread by the nanofiber covering material, permeate the material to the micro component surface, and are retained at the (hot) surface to fully evaporate. The micro component surface transfers a significantly larger amount of thermal energy to the evaporating drops compared to conventional spray cooling of microelectronic components, and the huge heat capacity associated with latent heat of water (or other liquid) evaporation can be fully leveraged. In these example systems and methods, the stronger evaporation provided permits more aggressive (higher volume) spraying, because the evaporation and cooling are stronger with the covered components. The effectiveness of example methods of the invention has been demonstrated, and is a surprising result, as it is counterintuitive to conclude that spray cooling could be enhanced by nanofiber material coverings that are naturally hydrophobic. Additionally, it would also be natural to assume that the covering would instead act as an insulator, as nanofiber materials act as insulators in many applications.

Preferred embodiments will now be discussed with respect to the drawings. The drawings include schematic figures that are not to scale, which will be fully understood by skilled artisans with reference to the accompanying description. Features may be exaggerated for purposes of illustration. From the preferred embodiments, artisans will recognize additional features and broader aspects of the invention.

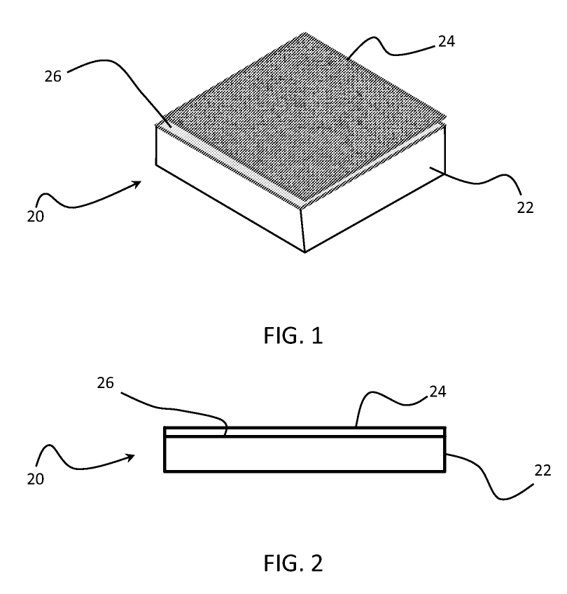

FIGS. 1-2 show an example device 20 for micro component cooling according to an embodiment of the present invention. The device includes a micro component 22 providing a substrate, as well as a nanofiber covering 24 for at least a portion of an external surface (or surface) 26 of the micro component. In particular example embodiments, the micro component 22 is a microelectronic component, such as but not limited to a microprocessor. This external surface 26 can be any external surface, such as but not limited to a front side or a backside surface of the micro component 22, and the present invention is not limited to covering a particular surface. Preferably, the surface 26 that is covered is a high heat flux surface, as a nonlimiting example having a heat flux of at least 1 kW/cm². As just one example, the surface 26 can be the casing of a microprocessor. Such a surface can have an operating temperature of 100° C. or higher.

As shown in FIGS. 1-2, the example nanofiber covering 24 can generally cover the entire area of a front side surface 26 of the micro component 22. This is not required, however, as the covering 24 may cover all or portions of the surface 26. The covering 24 may include more than one covering (e.g., piece of covering) provided on the same surface. The particular layout (e.g., geometric layout) for the covering 24 can vary. Further, the covering 24 can cover all or portions of more than one external surface, e.g., the front side and/or the backside surface, or cover any other suitable surfaces. Also, the example covering 24 is shown as directly covering the surface 26, but it is also contemplated that the covering may be indirect, such as if an adhesive or other layer is disposed between the covering and the surface. As a nonlimiting example, in the case of metallized nanofibers, they might be bonded to an underlying chip by the same metal, or using the chip material.

The example nanofiber covering 24 is a covering made of a porous, permeable material substantially formed as fibers having a cross-sectional diameter in the range of about 100-1000 nm (e.g., of the order of several hundred nanometers) (nanofibers). A nanofiber electrospun covering is preferred for the covering 24, because it results in both small inter-fiber pores (e.g., of the order of about several microns, as a nonlimiting example 5 microns) and high porosity (e.g., of the order of 90-95%). Preferably, the pores are filled with air. This example material provides both stronger wettability-driven penetration of liquid droplets and dynamically-assisted accumulation of kinetic energy for penetration as compared to microscopic and macroscopic fiber mats. Therefore, water (or other liquid) penetrates more easily. Also, the high porosity allows the example nanofiber covering 24 to take more water per unit volume compared to mats of microscopic and macroscopic fibers.

A nonlimiting example nanomat thickness is of the order of 100-200 microns, with a particular example thickness of about 200 microns. This example thickness is sufficiently large for creation of an intact coating on a substrate, with a high capability of pinning the contact line of a spread-out drop. On the other hand, a thickness of the order of 100-200 microns is sufficiently small to deliver practically all water (if water is used) into direct contact with the underlying surface 26.

In example embodiments the nanofiber covering 24 is a non-woven polymer nanofiber covering. The polymer used in the example covering 24 can be selected based on whether the polymer has a thermal stability within an operational temperature range of the micro component 22, and/or whether the polymer can be suitably deposited (e.g., electrospun, or electrospun and then transferred) on the micro component surface 26. As a nonlimiting example, for high heat microelectronics applications that can reach operational temperatures of about 100° C., a nanofiber covering including one of Polyacrylonitrile (PAN) and a Polymethyl methacrylate (PMMA) covering may be used. Other nonlimiting example polymers that may be used for the nanofiber covering 24 are described herein. However, it is also contemplated that suitable non-polymer materials may be used. In addition, nanofibers can be completely metallized and made hollow via chemical elimination of the template polymer nanofibers.

A non-woven nanofiber covering is preferred for the covering 24, because it arrests drop receding motion and bouncing and allows for an easy coolant access to the underlying chip/surface. Non-woven refers to fibers that are deposited in a mostly disordered manner, such as by electrospinning, meltblowing, solution spinning, or any other suitable method of making nanofibers. These fibers preferably are substantially randomly orientated in the covering plane (versus patterned fibers). In a particular example embodiment, the nanofiber covering 24 is embodied in a nanofiber mat, which in nonlimiting example embodiments is a generally flat piece (or several pieces) of non-woven polymer nanofiber material, preferably having small pores and high porosity (e.g., of the order of 90-95%), and a thickness of the order of 100-200 microns. For a nanofiber mat, non-woven refers to having fibers that are substantially randomly orientated in the mat plane.

To provide the nanofiber covering 24, a nanofiber material is provided, e.g., selected or manufactured, and the material is deposited onto a surface in a suitable manner to provide the covering. An example nanofiber material is a polymer that has a melting point that is higher than the operational range of the micro component to be cooled. In some example methods, the nanofiber material may be treated with other materials (as a nonlimiting example, carbon black nanoparticles) to provide composite materials. Example composite materials are described below, though these are not intended to be limiting.

An example deposition method is electrospinning. The provided polymer may be combined with a suitable solvent and electrospun onto a surface to provide the nanofiber material. Electrospinning may take place on the micro component 22 directly, or alternatively the material may be electrospun onto another surface and transferred to the micro component. Nonlimiting example electrospinning conditions are described below, though other conditions may be provided.

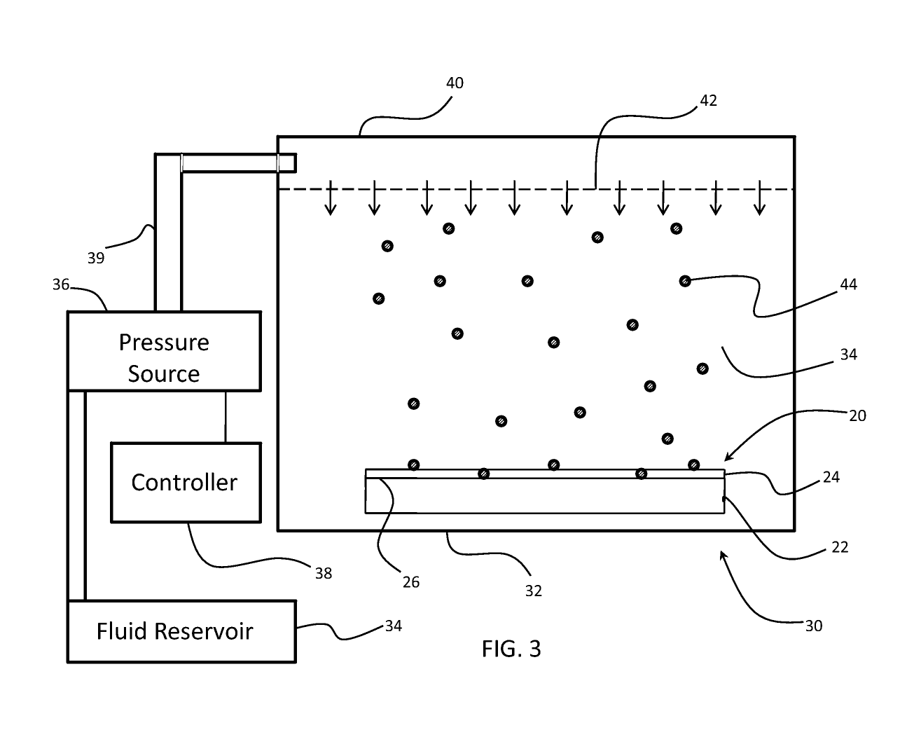

As shown in FIG. 3, an example cooled micro component system of the invention includes the device 20, including the micro component 22 and the nanofiber covering 24 (having surface 26), as well as a droplet spray system 30 for spraying liquid droplets onto the nanofiber covering to cool the micro component. The example droplet spray system 30 shown includes a chamber 32, which houses the device 20 in an interior 34 thereof. However, it is not required in all embodiments that the device 20 be housed in a chamber. Further, the chamber 32 may be a chamber used for purposes other than for cooling. For example, a computer housing, a room, etc. may provide a suitable chamber. Any of the devices 20 described above if suitable may be used with the droplet spray system 30.

For delivering liquid droplets to the nanofiber covering 24, the example droplet spray system 30 includes a liquid source, such as fluid reservoir 34 and a fluid pressure source 36 in fluid communication with the liquid source. The fluid pressure source 36, such as but not limited to a pump, is preferably selectively controlled by a controller 38. The fluid pressure source is in turn coupled via a channel 39 to a fluid distributor such as a manifold 40 or other distributor (e.g., spray chamber or spray head, nozzle, drain, microjets, etc.), which includes at least one and preferably plural fluid passages 42. In the example droplet spray system 30 shown in FIG. 3, the plural fluid passages 42 lead into the interior 34 of the chamber 32.

In an alternative embodiment using gravity to deliver liquid droplets, the manifold 40 or a fluid storage chamber or fluid distributor is positioned above the device 20, and fluid passage or passages are selectively opened or closed. A controller may be used to open or close the fluid passage or passages in this example embodiment. Liquid droplets selectively are distributed by gravity onto the nanofiber covering 24. However, example cooling methods of the invention can also work in weightlessness.

In an example operation of the example droplet spray system 30, the device 20, including the micro component 22 and the nanofiber covering 24, are placed into the chamber 32. Selective operation of the controller 38 causes the fluid pressure source 36 to draw liquid from the fluid reservoir 34 and to the manifold, where pressure from the pressure source (and/or in some embodiments gravity depending on the relative positions of the fluid distributor and the device) distributes (e.g., sprays) liquid through the passages 42. The liquid exits the passages 42 as liquid droplets 44, which are directed onto the nanofiber covering 24. The controller 38 can be configured to permit efficient spreading and evaporation of liquid permeating the nanofiber covering. The frequency of liquid delivery can be controlled via the controller 38.

In an example method for cooling the micro component 20, the directed liquid droplet 44 falls onto the nanofiber covering 24 that covers at least a portion of the micro component 22. This directed liquid droplet may be in the form of individual droplets or a spray containing droplets. In a nonlimiting example, drop impacts on partially wettable PAN had a water contact angle of 30-40°.

Example nanofiber coverings are in some cases poorly wettable by water if droplets 44 are softly deposited on their surface. This is related to the presence of texture on several scales (e.g., roughness or nanopores on the order of 1-10 nm, possible beads on individual nanofibers, nanofiber diameters of several hundred nanometers, and/or pore sizes of the order of several microns), which makes such nanofiber mats hydrophobic-like statically. However, when liquid droplets impact onto the nanofiber mats (even at low speeds of the order of 1 m/s), water and the other refrigerants can easily penetrate into the pores between nanofibers and reach the underlying surface, which means that the nanofiber mats are fully wettable dynamically. The latter is due to the accumulation and channeling of the kinetic energy of droplet impact into flow in the pore with speeds much higher than the wettability-driven flows, which makes nanofiber mat wettability completely or almost immaterial.

Due to properties of the example nanofiber covering, the liquid droplet does not substantially splash, bounce, or recede when it reaches the nanofiber covering, even when directed from a distance. Instead, the liquid droplet 44 efficiently spreads through a portion of the nanofiber covering 24, entering pores of the covering and permeating the covering. Drop spreading after impact for example nanofiber coverings 24 can be similar to that on impermeable surfaces, but the drop contact line can become pinned at the end of spreading, leading to a significant enhancement of cooling of hot nanofiber-covered surfaces in drop or spray cooling. The permeated liquid droplet 44 reaches the (hot) surface 26 of the micro component 22, where it is retained at the surface to fully evaporate. The surface 26 transfers to the liquid droplet 44 a significantly larger amount of thermal energy versus conventional spray cooling. While the effect of a single drop is shorter (albeit stronger) than if the drop were delivered on an uncovered substrate, the droplet spray system 30 can be selectively controlled to provide multiple drop impacts and thus provide longer and more efficient cooling periods.

Experiments to demonstrate example embodiments of the invention will now be discussed. Artisans will appreciate broader aspects of the invention from the experiments.

### Experiment 1

In a first experiment, electrospun nanofiber material having a thickness of about 100 μm was demonstrated to significantly enhance cooling over cooling uncovered surfaces or surfaces covered with a wettability promoter. For example, for a substrate with an initial temperature of 60° C., a direct impact of a single water drop (as in current spray cooling methods) reduced temperature to about 43° C., whereas an impact on a 100 μm polyacrylonitrile (PAN) nanomat further reduced temperature to about 33° C. The experiments show that PAN and PMMA nanofiber coverings are well-suited for cooling of microelectronic components. PCL and polyurethane elastomer (PU) nanofiber coverings are suitable for lower temperature applications, as the operational range of typical microelectronic components can cause melting of PCL and PU coverings. Many other polymers can also be used to produce coverings suitable for the enhancement of the spray cooling of microelectronic components.

The experiments used electrospun polymer materials. Four polymers were tested. PCL (Mw=80 kDa), PMMA (996 kDa), and PAN (150 kDa) were purchased from Sigma-Aldrich. Polyurethane elastomer (PU, Tecophilic SP-80A-150) was purchased from Lubrizol. The following solvents were used to prepare polymer solutions for electrospinning: Dimethylformamide (DMF), Dichloromethane (MC), Tetrahydrofuran (THF) and Ethanol (all purchased from Sigma-Aldrich). CB 200 grade carbon black nanoparticles used to electrospin nanocomposite nanofibers were purchased from Cabot Corporation. All the materials were used without any further purification or processing.

The electrospinning conditions used in the experiments are listed in Table 1 together with the as-spun nanofiber sizes (cross-sectional diameters), which were determined using Olympus-BX51 optical microscope. The PCL-CB composite nanofiber was produced by adding 10% CB w.r.t. PCL in the polymer solution. All the polymers were dissolved in their respective solvents and mechanically stirred at 50° C. for around 5 hr. All the electrospun coverings were collected on a horizontal flat stainless steel plate except for PMMA, which was collected on a slow-rotating flat disk. The electrospinning process was carried out under room temperature (24° C.) at a relative humidity of 22-24%. Thickness of deposited nanofiber coverings increases linearly with deposition time at rates about 32 nm/min.

TABLE 1

| | | | | | Electric | |
|---|---|---|---|---|---|---|
| | Molecular | | | | field | |
| | weight | Conc. | | | strength | Size ~ |
| Polymer | (kDa) | (%) | Solvent | Ratio | (kV/cm) | (nm) |
| PCL | 80 | 11 | DMF/MC | 40/60 | ~1.4 | 540 |
| PCL-CB | 80 | 11 | DMF/MC | 40/60 | ~1.4 | 570 |
| PMMA | 996 | 11 | DMF | — | ~1 | 1500 |
| PAN | 150 | 12 | DMF | — | ~1 | 400 |
| PU | 225 | 10 | Ethanol/THF | 80/20 | ~1 | 600 |

The example nano-textured coverings formed can be considered as mats. Droplet Cooling tests were conducted with 19 μm stainless steel stripes covered with example polymer nanofiber “mats”. Water drops falling under gravity were used to evaluate the cooling effect of example nanofiber coverings on surfaces found in micro components such as microelectronic components. Open surfaces (without a nanomat covering) and surfaces covered with a wettability promoter were also tested. It should be noted that coverings of the invention are not limited to surfaces, but should be applied three-dimensionally to micro components including microelectronic components.

The example electrospun nanofiber mats were cut into small, almost rectangular pieces and stacked inside Tzero Aluminum pans (Cat. No. T081120). The weight of each of the nanofiber mat pieces was between 2-4 mg depending on the electrospinning deposition time. The aluminum pans were sealed with their corresponding lids to ensure negligible loss of polymer mass during heating. Differential Scanning Calorimetry (DSC) was conducted using DSC Q200, TA instruments. The instrument was ramped at 10° C./min under a constant flow rate of 50 mL/min nitrogen. All the samples were initially equilibrated at 20° C. before their thermal analysis had been started. A similar procedure was adopted in the case of bulk pellets of the same polymers. The thermal and structural properties of the bulk polymers in the pellets found in literature are listed in Table 2. All the experiments were carried out twice to ensure reproducibility.

TABLE 2

| | | Glass transition | Melting |
|---|---|---|---|
| | | temperature | point temp. |
| Polymer | Structure | (° C.) | (° C.) |
| PCL | Crystalline [23] | −60 [22.25] | 60 [23] |
| PMMA | Crystalline [24] | 125 [24]* | 300 [24]* |
| PAN | Amorphous | 85 [26] | 317 [26] |
| | [27] | | |
| PU | Amorphous* | −40* | 175* |

*Information provided by the manufacturer.

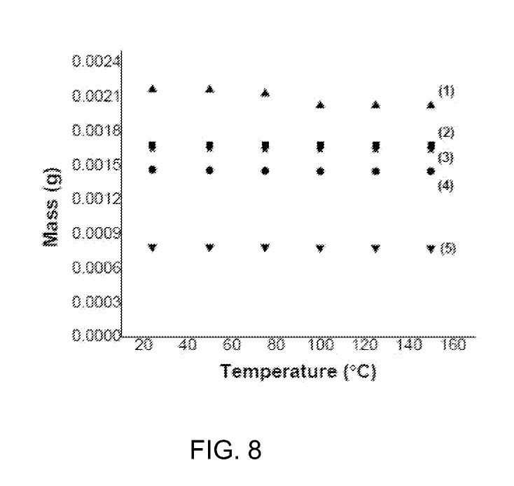

Pieces of electrospun nanofiber mats were stacked and weighed using SARTORIUS LE26P Microbalance equipment. The mats were heated at various temperatures (in the range 24° C.-150° C.) for 15 min each and weighed again. The heating was done in open atmosphere. The results are shown in FIG. 8 and Table 3. These measurements were repeated twice to ensure reproducibility.

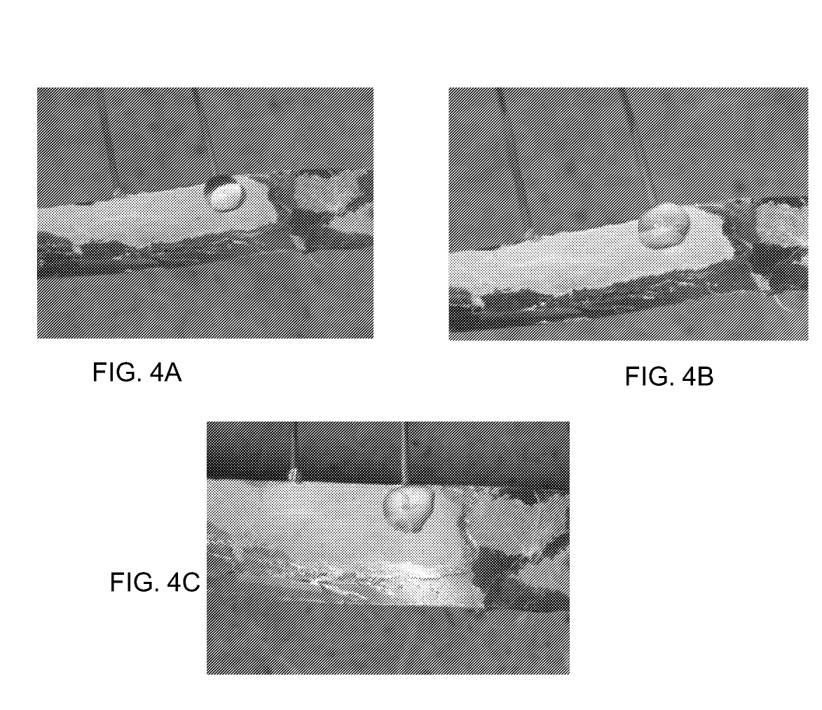

FIGS. 4A-4C show images of drops deposited on unheated strips covered with PAN nanomats: (a) immediately after a soft deposition; (b) 10 min after deposition; and (c) 17 min after deposition. Water drops impacted warm 10 μm stainless steel stripes. A first stripe was covered by PAN nanomat (non oriented). A second stripe was tested (i) without any covering (referred to as “plain steel” in the figure legends). A third stripe was used (ii) with a “wettable” covering, which improves wettability (referred to as “plain steel covered” in the figure legends).

After a soft deposition of a drop onto an unheated stripe covered with a PAN nanomat, a very high contact angle is observed (FIG. 4A). After several minutes water begins to penetrate into the nanomat (FIGS. 4B-4C). Initially the nanomat acts effectively as a super-hydrophobic surface, since most of its bulk is just air (the porosity is of the order of 90% and the pores are filled with air). The nanofiber material is typically partially wettable, but with the contact angle values close to 90°. Therefore, it takes a relatively long time until weak wettability and gravity force result in a partial impregnation of such mats by gently deposited water drops. In some cases there is no impregnation at all.

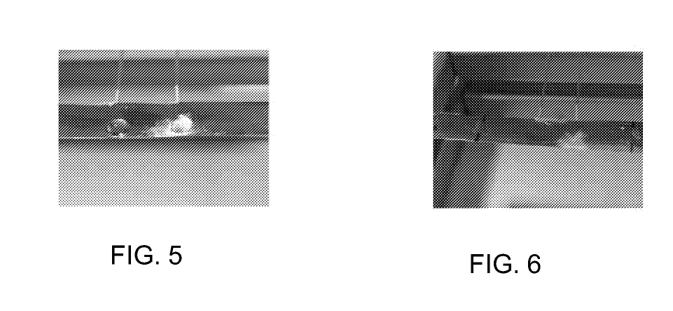

The shapes of the drops gently deposited on an unheated stripe without covering, and the stripe with the “wettability” covering, are shown in FIGS. 5 and 6, respectively. FIG. 5 shows two drops gently deposited on an uncovered steel stripe. Reflections appear at the region where the surface has been artificially roughened to increase wettability (without much effect). FIG. 6 shows a drop deposited on a steel stripe covered with “wettability” promoter. The wettability of the uncovered steel surface is rather poor, whereas it is significantly improved after the application of the “wettability” promoter.

For the heat transfer experiments, two thermocouples were attached to the back side of each stripe (seen in FIGS. 4-6). The distance between their joints was 1 cm. In all the heat transfer experiments the stripes were heated by electric current with a “constant” power so that the initial temperature measured by both thermocouples was about 60° C. After the achievement of steady temperature values, the cooling experiments were conducted.

In the first experiment, a water drop with a diameter of about 3 mm was gently deposited exactly above the left thermocouple. The temperature measurements of both thermocouples were recorded until the drop was completely evaporated. In the second experiment, a similar drop fell down and impacted the stripe at the location of the left thermocouple from a height of 10 cm, and the cooling effect was recorded. In the third experiment, a similar drop fell down at the location of the left thermocouple from the height of 15 cm. The measurements were repeated with the drop deposition/impact over the location of the right thermocouple as well, to check the reproducibility. The data storage started immediately before the deposition (or release) of the drops.

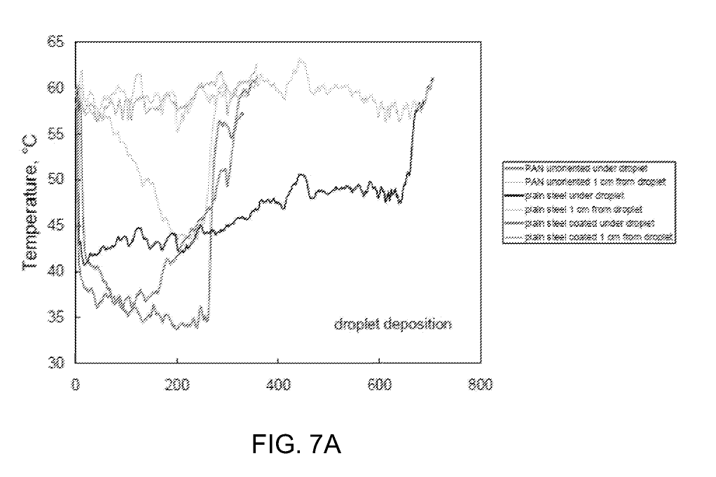

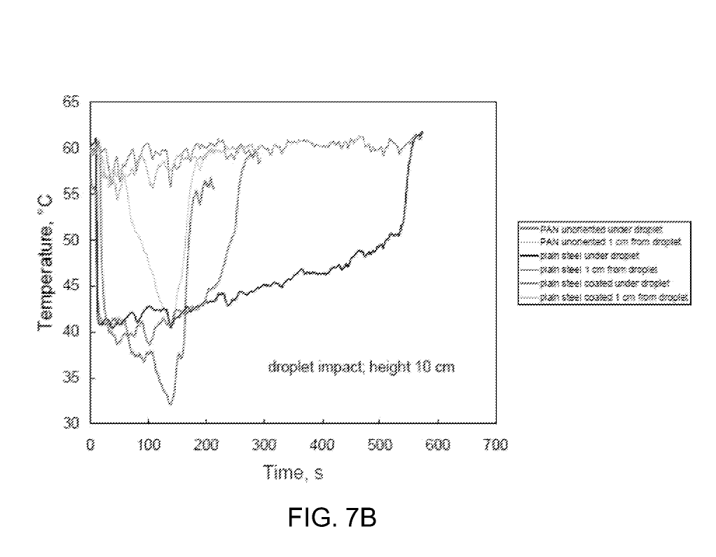

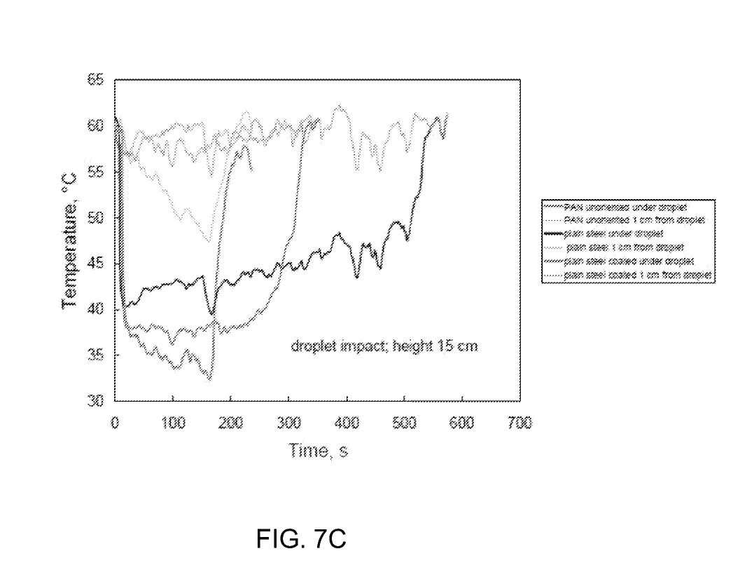

The results of the heat transfer experiments are shown in FIGS. 7A-7C. FIG. 7A depicts the results obtained after a gentle drop deposition, while FIGS. 7B-7C show the results obtained with drops falling down from the heights of 10 cm and 15 cm, respectively. As seen from the legend, the mahogany curves represent the temperature-versus-time curves for the nanomat-covered stripes, the green curves show the results with the “wettability”-covered stripes, and the blue curves represent the uncovered stripes. The thick lines represent the temperature histories measured directly under the drop, and the thin lines represent the corresponding temperature histories measured at the distance of 1 cm from the drop impact location. It is seen from FIGS. 7A-7C that the cooling effect of a single drop deposition (impact) on a nanomat-covered stripe reduces stripe temperature at least at the distance of 1 cm, which results from the water sucking and spreading in the capillary structure and evaporation there in contact with the substrate.

The experimental results depicted in FIGS. 7A-7C show that the cooling effect of a single drop impacted on an example nanomat is shorter (albeit stronger) than that on an uncovered substrate or a substrate covered with “wettability” promoter. This is because drop evaporation in the example nanomat is fully completed in a relatively short time, in close contact with a warm substrate. In spray cooling with multiple drop impacts, longer cooling periods can be achieved with droplet control. Thus, in the example droplet and spray cooling systems 30 having micro components 22 covered with nanofiber materials 24, the stronger evaporation provided permits more aggressive (higher volume) spraying, because the evaporation and cooling are stronger with the covered components.

Microelectronic equipment is typically sustained at temperatures below 100° C. For such applications, example nanometal coverings according to embodiments of the present invention when used to cool microelectronic equipment should withstand about 100° C. without melting. This temperature may be different for cooling of other micro components. Bulk and nanofiber materials have disparate properties, so data regarding glass transition and melt temperature of the corresponding bulk polymers may provide little guidance, since it is expected that these characteristics are reduced in nanomaterials.

Experiments were conducted with PCL, PCL-CB, PMMA, and PU nanofiber mats according to example embodiments of the invention to determine their suitability for microelectronic component cooling applications.

TABLE 3

| Polymer | PCL | PCL-CB | PMMA | PAN | PU |
|---|---|---|---|---|---|
| Average mass loss (%) | 0 | 0.4854 | 0.956 | 6.642 | 1.2723 |

FIG. 8 presents data concerning the masses of example polymer nanofiber mats at room temperature and after 15 min heat treatment at different temperatures. In FIG. 8, the data refers to: (1) PAN, (2) PCL, (3) PCL-CB, (4) PMMA, and (5) PU. The data error bars are ±2 μg. The masses of polymer nanofiber mats were weighed at room temperature and after 15 min heat treatment at different temperatures. Corresponding mass losses averaged over the entire temperature range are listed in Table 3. The average mass losses after the heat treatment for PCL, PCL-CB, PMMA, and PU mats do not exceed 1-1.5%. On the other hand, PAN mats lost about 7% of their mass on average. FIG. 8 elucidates that most of the mass losses in PAN mats occur in the range of 75° C.-100° C. This is further corroborated by DSC analysis for PAN, described below.

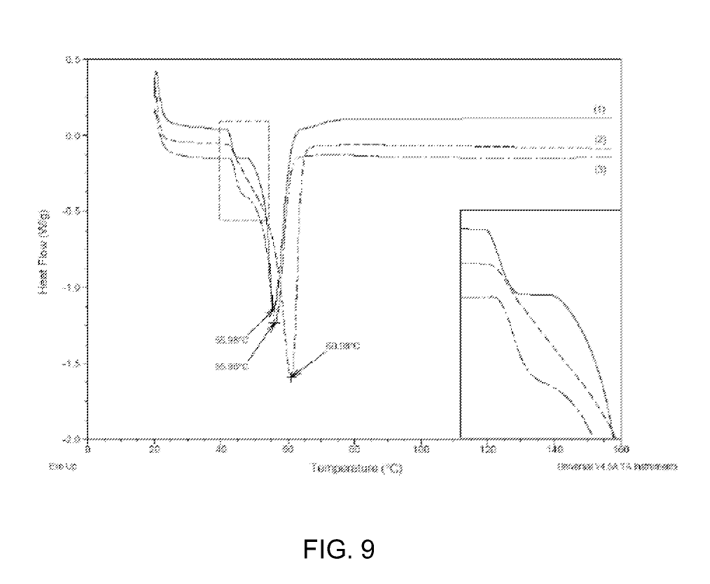

DSC thermograms for PCL nanofiber mats and pellets are shown in FIG. 9. These include: (1) PCL nanofiber mat electrospun from 11% PCL solution; (2) PCL pellet; and (3) electrospun PCL-CB nanocomposite nanofiber mat. The DSC thermograms for PCL show several features. First, there is a significant reduction in the melting point of electrospun PCL nanofibers and nanocomposite PCL nanofibers compared to that of PCL pellet, in distinction from reported results for PCL where the nanofibers were compressively molded at 50° C. in prior DSC measurements. The data in FIG. 9 show that the melting point was reduced from 60.8° C. for PCL pellets to 56° C. for PCL nanofibers. The decrease in the melting temperature may be attributed to three phenomena previously mentioned in the literature: (i) high surface to volume ratio of the electrospun fibers; (ii) plasticizing effect of a residual solvent in the nanofiber mats on the polymer chains; and (iii) modification of the crystalline structure as a result of rapid solidification of polymer solutions in electrospinning. The experimental data, however, attributes the third phenomenon to the developments observed in FIG. 9 around 42° C. At this temperature both types of nanofibers demonstrate a visible thermal signature of realignment of macromolecular chains and possible crystallization well before melting. DSC was also used to measure crystallinity. The electrospun PCL nanofibers had 66.28% crystallinity of the one characteristic of the PCL pellets.

FIG. 9 shows various DSC thermograms for PCL: (1) PCL nanofiber electrospun from 11% solution; (2) PCL pellet; and (3) PCL-CB nanocomposite nanofiber mat. The data corresponding to the rectangular frame on the left is scaled up in the rectangle on the right.

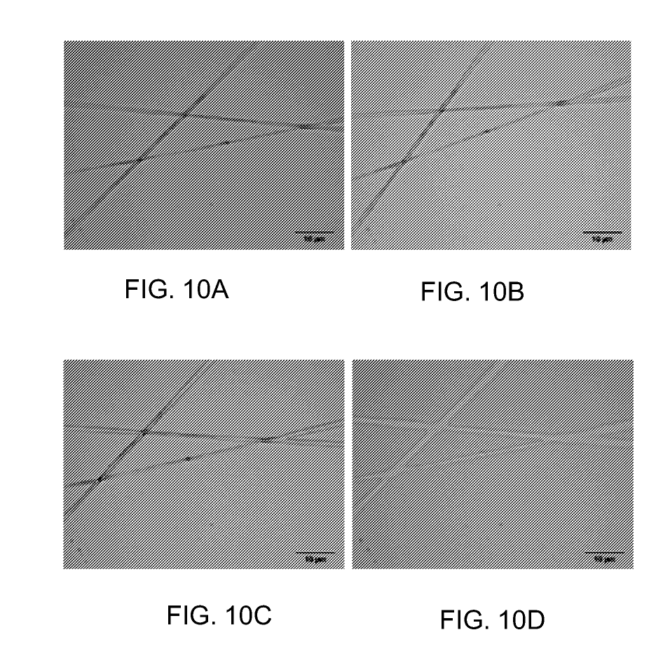

The glass transition temperature of PCL is around 60° C. Therefore, with no observable baseline shift, the phenomena occurring with PCL nanofibers around 42° C. cannot be attributed to glass transition. The DSC thermograms for PCL are accompanied by optical observations of junctions of individual nanofibers caught on a glass slide moved above the ground electrode. The junctions were observed at different temperatures, and the results for PCL are depicted in FIGS. 10A-10D. The observable deformations of the nanofibers begin near to their junctions around 50° C.

Smoothing is due to the action of surface tension (which is largest at the junctions where local curvature of material is very large), which results in viscous creeping flow of softened polymer. Such flow can accompany structural rearrangements of macromolecular chains in re-crystallization, as well as to the ultimate crystalline melting close to 60° C. FIGS. 10A-10D show optical images of junctions of individual PCL nanofibers at different temperatures: (a) 36.5° C.; (b) 49.3° C.; (c) 53.55° C.; and (d) 59.9° C.

The morphological changes depicted in FIGS. 10A-10D clearly correspond to the left hand side slope of the depressions for nanofibers seen in FIG. 9. The optical images in FIGS. 10A-10D show deformation near the nanofiber junctions and change in optical image contrast, indicating apparent melting between 53° C. and 60° C., although no overall observable features could be seen below the melting temperature.

Presence of carbon black (CB) nanoparticles in PCL nanofibers slightly shifts the corresponding DSC thermogram toward that of PCL pellets in FIG. 5. CB nanoparticles also altered the molecular rearrangement, as the data in FIG. 9 show, whereas the melting temperature remained practically the same as in pure PCL nanofibers. Particularly, the measured crystallinity in PCL-CB nanofibers was found to be 64.9%, almost the same as in PCL nanofibers. The thermal treatment of bulk fibers showed results similar to pure PCL fiber mats.

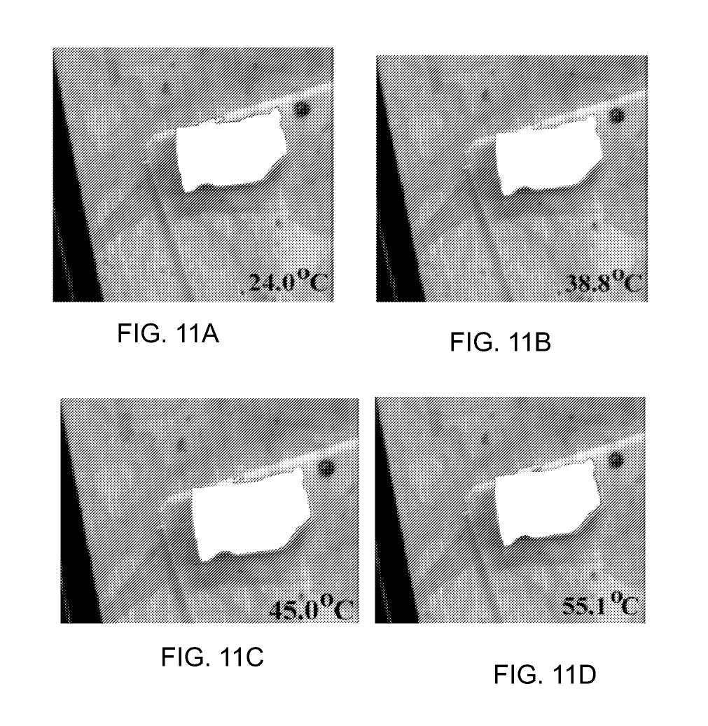

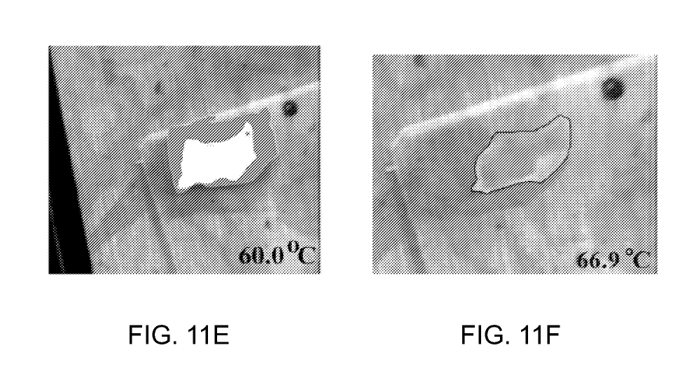

Optical images of the PCL nanofiber mats during heat treatment are shown in FIGS. 11A-11F. Mat shrinkage is illustrated by the shrinkage of the white area on the grey background, corresponding to the sample at room temperature. The visible overall changes in the PCL nanofiber mats begin at 45° C. At 66.9° C. the sample was completely molten. For this reason, PCL nanofiber mats (with or without CB nanoparticles) may not be optimal for use in spray cooling of microelectronics components or other micro components that operate above 45° C.

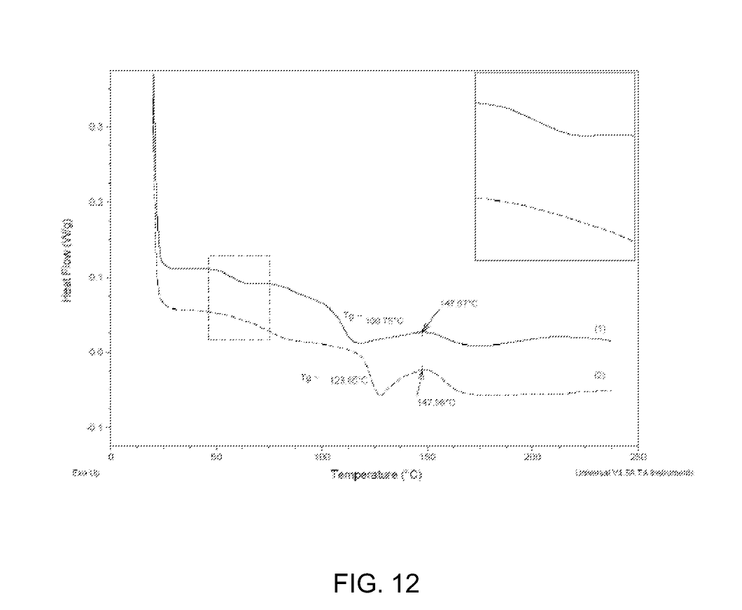

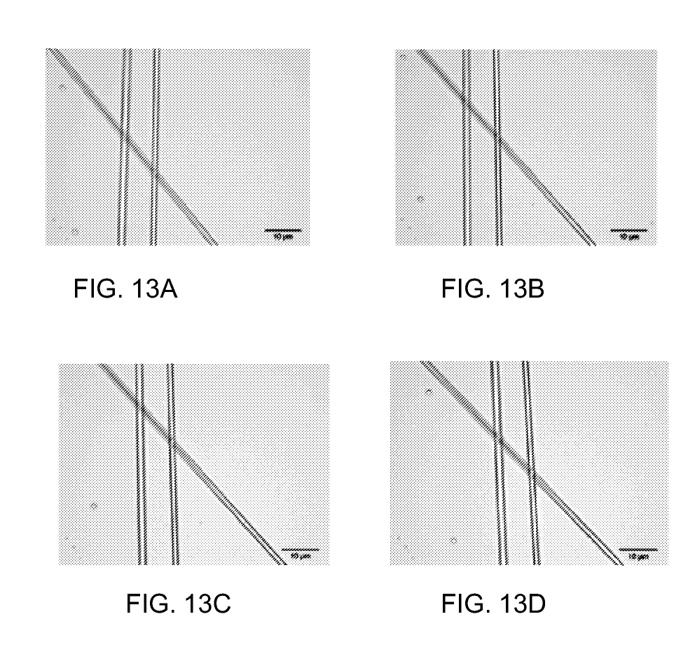

DSC thermograms for (1) PMMA nanofiber mats electrospun from 11% and (2) PMMA powder are shown in FIG. 12. The data corresponding to the rectangular frame on the left is scaled up in the rectangle on the right. PMMA is a crystalline polymer, and electrospinning reduces crystallinity due to rapid evaporation of solvent and solidification of the polymer. Crystallinity of example PMMA nanofibers was determined via DSC and found to be 50.15% compared to that of PMMA powder. The inset in FIG. 12 shows a “dip” at 60° C. in the thermogram for PMMA nanofibers. This feature is absent in the thermogram for PMMA powder. The “dip” results from the annealing of nanofibers, which leads to an increase in crystallinity. Therefore, this “dip” in the thermogram should be attributed to molecular rearrangement of PMMA chains within nanofibers at 60° C. (a phenomenon similar to one observed in the thermogram of PCL nanofibers around 40° C.). For PCL nanofibers, such rearrangement happens well above the glass temperature and is followed by melting. On the contrary, for the example PMMA nanofibers, the rearrangement and re-crystallization of polymer chains happens before the glass transition. Indeed, the thermogram for PMMA nanofibers in FIG. 12 shows glass transition at 109° C., which is much earlier than for PMMA powder (the glass transition at 124° C.). The decrease in the glass transition temperature of these PMMA nanofibers corresponds to their lower crystallinity compared to that of PMMA powder. At still higher temperatures, both PMMA nanofibers and PMMA powder likely undergo a depolymerization/degradation around the same temperature of 148° C. (FIG. 12). This observation likely indicates that the glass transition temperature might be the threshold point where the internal structure and properties of the example electrospun PMMA nanofibers match up with those of the PMMA powder. The optical images of the junctions of PMMA nanofibers at different temperatures: (a) 33.3° C.; (b) 50.9° C.; (c) 90.7° C.; and (d) 125.7° C. are shown in FIGS. 13A-D. It shows that neither macromolecular rearrangement and re-crystallization nor glass transition produce any visible sintering-like flow even in the locations of high curvature near nanofiber junctions.

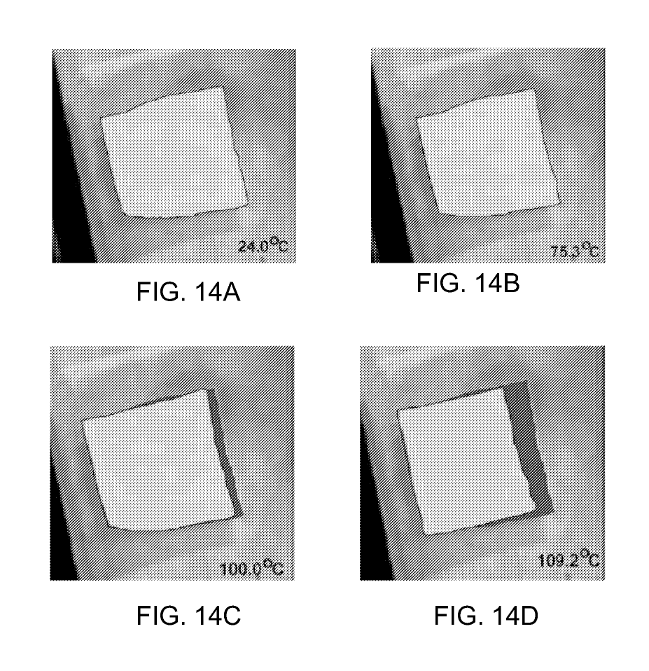

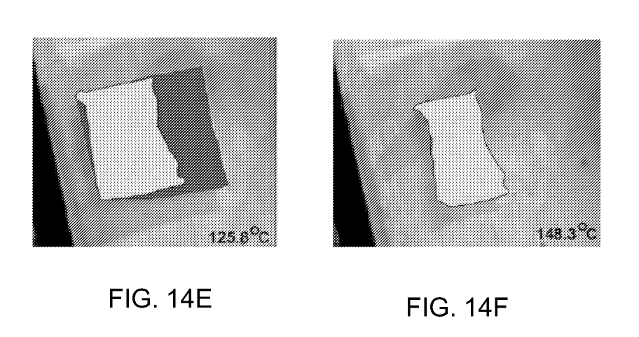

Optical images of example PMMA nanofiber mats during heating are shown in FIGS. 14A-14F. Shrinkage of the grey area over the black one illustrates the sample evolution compared to its initial configuration. The last frame in FIG. 14F at 148.3° C. depicts the final example mat configuration. Thus, the example PMMA nanofiber mats will work well in spray cooling of microelectronic systems up to 100° C.

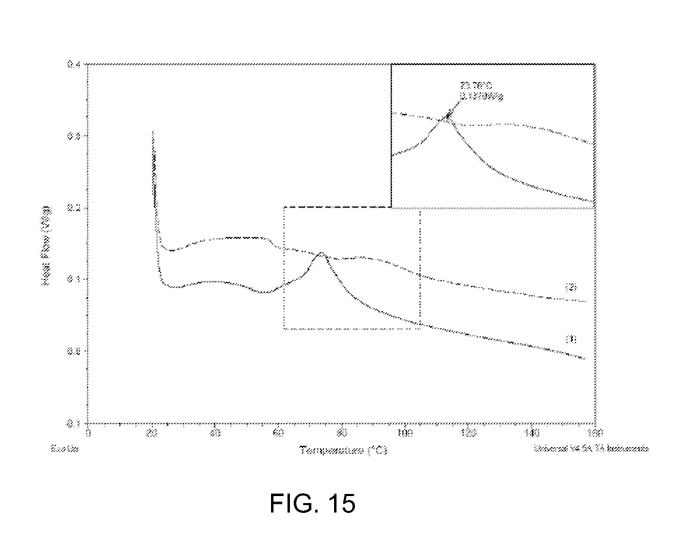

DSC thermograms for PAN nanofibers electrospun from a 12% solution and for PAN powder are shown in FIG. 15, where: (1) PAN nanofibers electrospun from 12% solution; and (2) PAN powder. FIG. 15 demonstrates an exothermal peak with specific heat release of about 0.137 W/g around 73.76° C. for PAN in a nanofiber mat, in distinction from PAN powder. The results for PAN shown in FIG. 8 and Table 3 suggest a significant mass loss around this temperature. However, the example DSC procedure does not allow any mass losses. Therefore, the exothermal peak can be attributed to a change in the specific heat at constant volume, cv, of the specimen. The reason for the above-mentioned mass losses may be due to (i) a partial degradation of PAN nanofibers around this temperature or (ii) a chemical reaction—both triggered by oxidation process at the nanofiber surface.

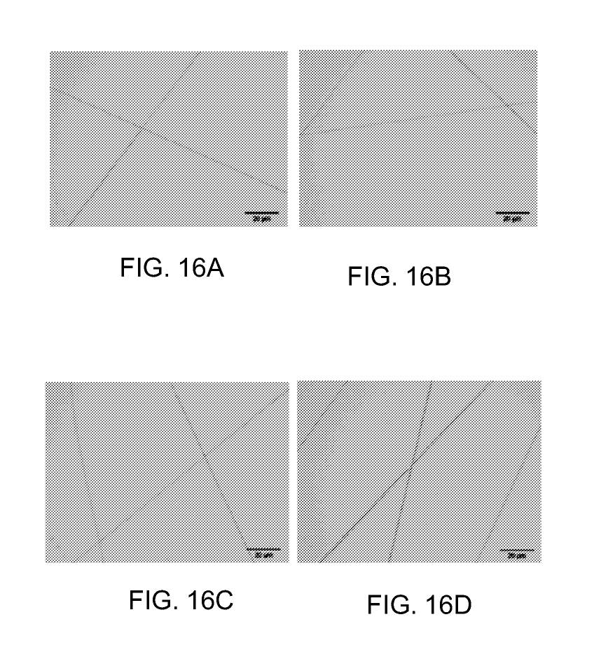

FIGS. 16A-16D show optical images of junctions of individual PAN nanofibers at different temperatures, particularly (a) 35.3° C., (b) 68.1° C., (c) 90.1° C., and (d) 125.0° C. These images show no observable changes in the PAN nanofiber crossbars around 73.76° C. Only at a much higher temperature (˜125° C.) is a minor bending near the junction visible (FIG. 14D.) The overall images of PAN nanofiber mats (not shown here), however, did not show any observable changes for any temperature up to 150° C. This makes example PAN nanofiber mats fully appropriate for spray cooling systems in microelectronics in the whole temperature range of interest.

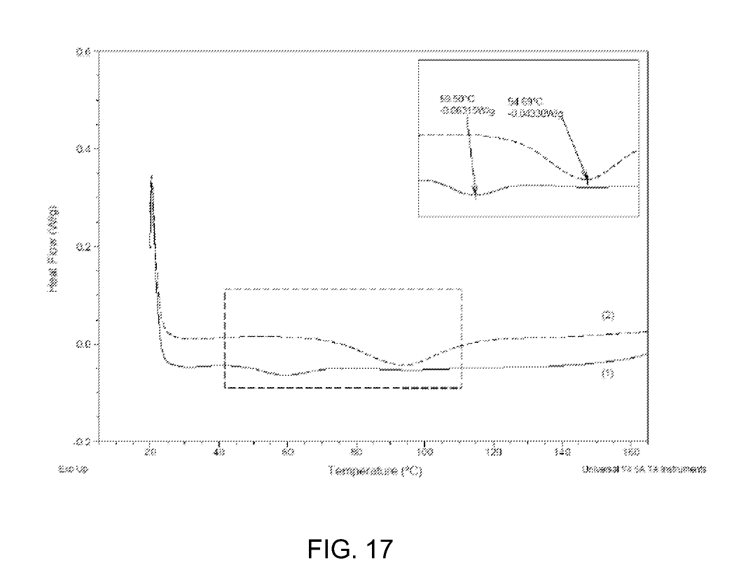

DSC thermograms for PU are shows in FIG. 17. Depressions in the thermograms are visible for both nanofiber and pellets, albeit at different temperatures. The depressions are interpreted as molecular chain rearrangements. PU nanofibers begin to undergo such rearrangement at a lower temperature of about 50° C. compared to PU pellets (about 85-90° C.). Shift of the rearrangement to a lower temperature in PU nanofibers is similar to the correspondent phenomena observed for PCL and PMMA nanofibers. However, behavior of PU nanofibers at higher temperatures is qualitatively different. The PU nanofiber thermogram is similar to that of PU pellet. The PU thermograms also showed crystallization, but at a higher temperature (around 210° C.) for both nanofibers and pellets (not shown in FIG. 17).

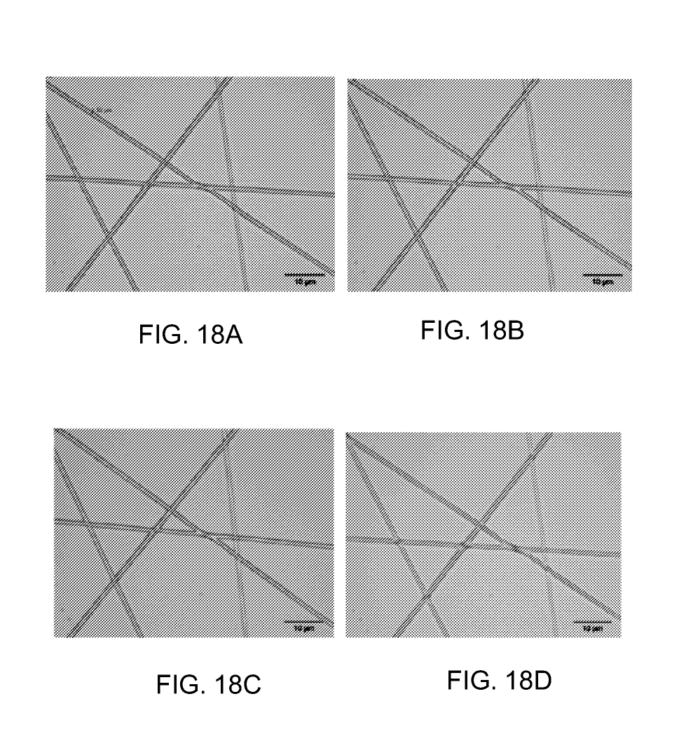

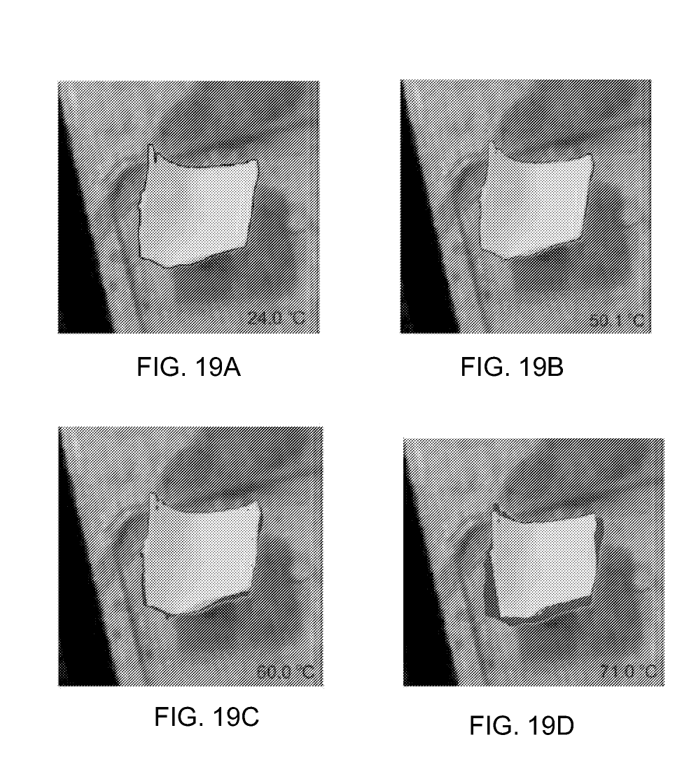

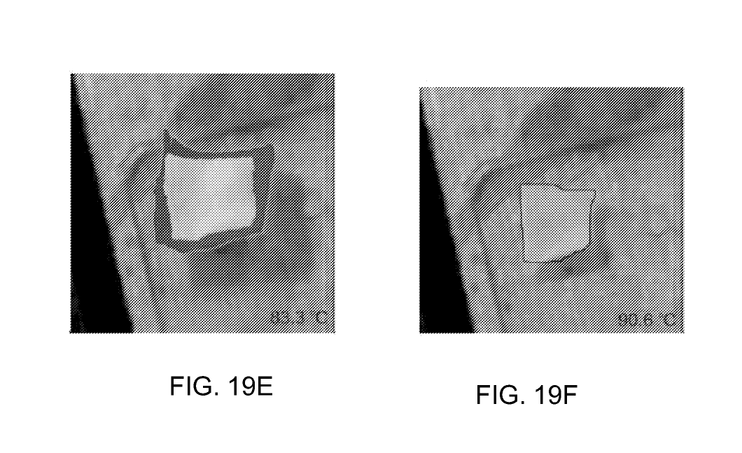

FIGS. 18A-18D are optical images of junctions of individual PU nanofibers at different temperatures, where: (a) 26.7° C.; (b) 40.8° C.; (c) 53.8° C.; and (d) 87.5° C. The optical images of the PU nanofiber junctions in FIGS. 18A-18D show that sintering-like flow begins above 60° C. The overall images of the PU nanofiber mats subjected to heat treatment shown in FIGS. 19A-19F reveal a considerable shrinkage/creep as the temperature exceeds 50° C. Therefore, PU nanofiber mats are best suited in spray cooling systems of microelectronics at temperatures or other components that do not exceed about 50° C.

### Experiment 2

The second set of experiments relate to the physical phenomena taking place after water drops impact on surfaces coated with example nanomats. In particular, the effect of wettability and roughness of nanofiber materials on the outcome of the impact, as well as in the effect of the impact conditions on such phenomena as pinning of contact line, receding motion and splashing (if any), were considered.

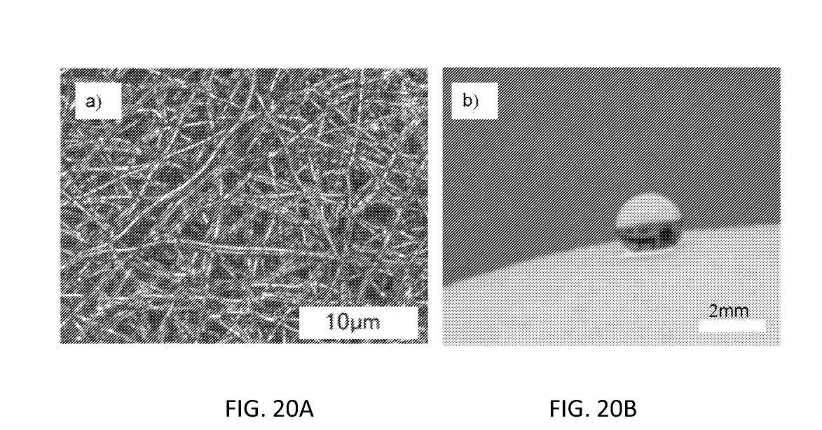

Nanofibers were electrospun from PAN (Polyacrylonitrile, a partially wettable polymer with water contact angle on a cast sample of about (30-40°, PCL (Polycaprolactone, a non-wettable polymer, with water contact angle on a cast sample over 90°), or from PCL containing CB (carbon black nanoparticles), which tends to increase roughness of individual nanofibers. The electrospinning setup is described in Reneker, D. H., Yarin, A. L.; Zussman, E.; and Xu, H., Adv. Appl. Mech., 2007, 41, 43-97. Circular nanomats of diameter of about several centimeters, with thickness of the order of several hundred microns and porosity of the order of 90% were produced. FIG. 20A depicts a laser scanning microscope image of a PAN nanomat used in the experiments. This image provides information on three-dimensional topology of example nanomats. Nanomats were electrospun on copper discs attached to a grounded electrode. The discs with nanomats on their top were used as targets in drop impact experiments. Copper discs with flat or rounded tops were used, which made the corresponding nanomats on top either plane or rounded, respectively. The slightly convex rounded top shown in FIG. 20B is only used for better illustration of the hydrophobic-like behavior of a droplet of about 0.5 mm in diameter, softly deposited on the surface (partially wettable PAN nanofibers).

Advancing and receding contact angles of a water drop of about 1 mm in diameter on the nanomat surfaces were measured optically. All three samples showed large advancing contact angles: 103° for PAN, 108° for PCL and 100° for PCL+CB. In the case of non-wettable PCL (with or without CB), the advancing contact angle on nanofibers is close to the one on a cast sample.

On the other hand, on PAN nanofibers the contact angle is significantly larger than that on a cast sample, which is explained by the fact that air entrapped in the pores (about 90-95% porosity) facilitates hydrophobicity, even though the nanofibers are made of a relatively wettable material. This refers to the so-called Cassie-Baxter regime. The receding contact angle approaches zero, indicating a very large hysteresis. Since this effect occurs on all of the example nanomat surfaces studied in this experiment, irrespective of their chemical structure and roughness, it is deemed to be a result of their porous structure. A rolling-off angle for water drops on nanomats is not present.

Drops of about 0.5 mm softly deposited on these example nanofiber mats look spherical. They almost do not change their shape when flipped upside down, and do not detach from the surface. This characteristic can be beneficial for the example cooling methods provided herein, since such cooling is possible at any surface irrespective of its orientation with respect to gravity. Thus, as provided above, the surface or surfaces to be covered are not limited to the example front side surfaces shown in certain figures.

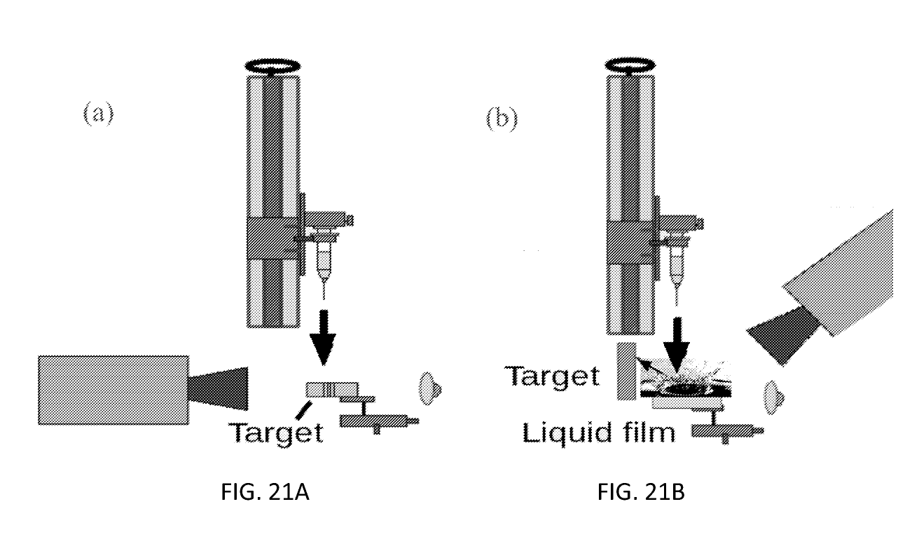

At the initial stage, drop impacts onto example nanomats are governed mainly by the inertia dominated flow in a spreading drop over the mat surface. At the later stages, drop spreading is arrested, the contact line is pinned, and liquid penetrates into porous nanomat. Experiments with drop impacts on nanomats were performed to observe the impact phenomena using a high-speed video system. Two configurations of the experimental setup used are shown in FIGS. 21A-B. In the first configuration (FIG. 21A) a drop produced by a drop generator is accelerated by gravity and then impacts onto a horizontal target. A laboratory syringe used as a drop generator produces drops of 2-3 mm in diameter, whereas a commercial piezoelectric drop-on-demand device (Microdrop) generates drops of approximately 100 μm in diameter.

The second configuration (FIG. 21B) is designed to investigate impact of drops in an intermediate diameter range (0.4 to 1.4 mm). In this configuration an impact of a primary drop onto a horizontal wetted impactor generated several secondary droplets. Some of these secondary droplets then collided with the coated surface of the vertically oriented target. The outcome of these collisions was captured by the high-speed video system and then analyzed.

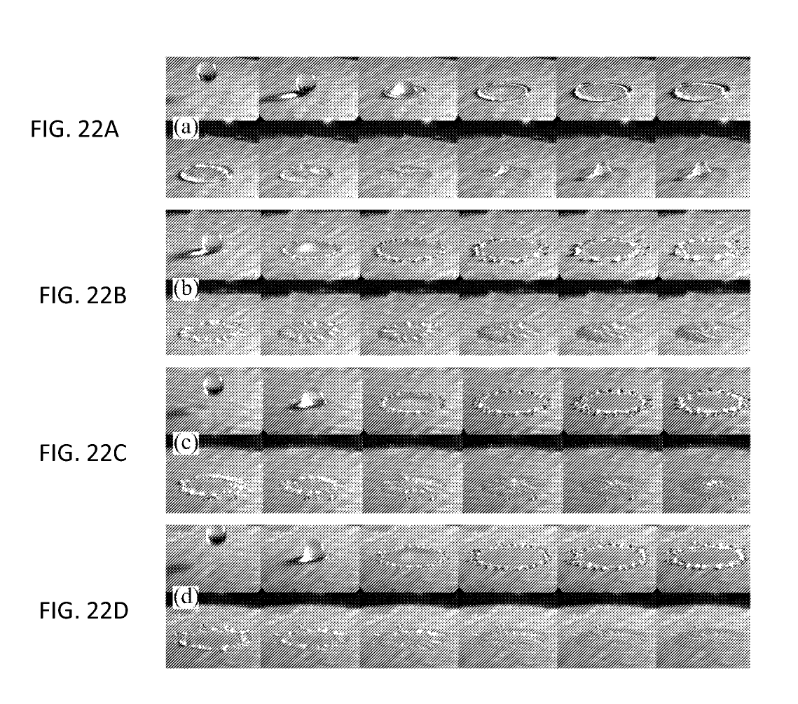

A small drop softly deposited on the example nanomat surface is almost spherical (FIG. 20B), demonstrating a seemingly hydrophobic-like state. However, after several minutes this drop spreads out and is partially sucked into the example nanofiber mat. After about 10 min the drop completely disappears from the nanomat surface, as described in more detail below. A totally different outcome was observed when a water drop of 2 mm diameter impacted onto the same nanomat at a speed of 2 m/s. As FIG. 22A shows, the drop first spreads on the example nanomat surface as on a dry, rigid, completely wettable substrate, and then the drop remains pinned in the spread-out configuration and does not recede.

FIGS. 22A-D demonstrate that an impacting drop, depending on its velocity and diameter, can develop different spreading modes ranging from deposition-like to splash-like ones. All the types of drop behavior shown in FIGS. 22A-D (deposition, fingering without splash, receding splash, and advancing splash, respectively) are familiar from drop impacts on impermeable surfaces. However, there are significant distinctions characteristic of drop impacts on example nanomats. For example, a corona splash, similar to that of drops impacting on thin films of water, was not observed, nor was bouncing.

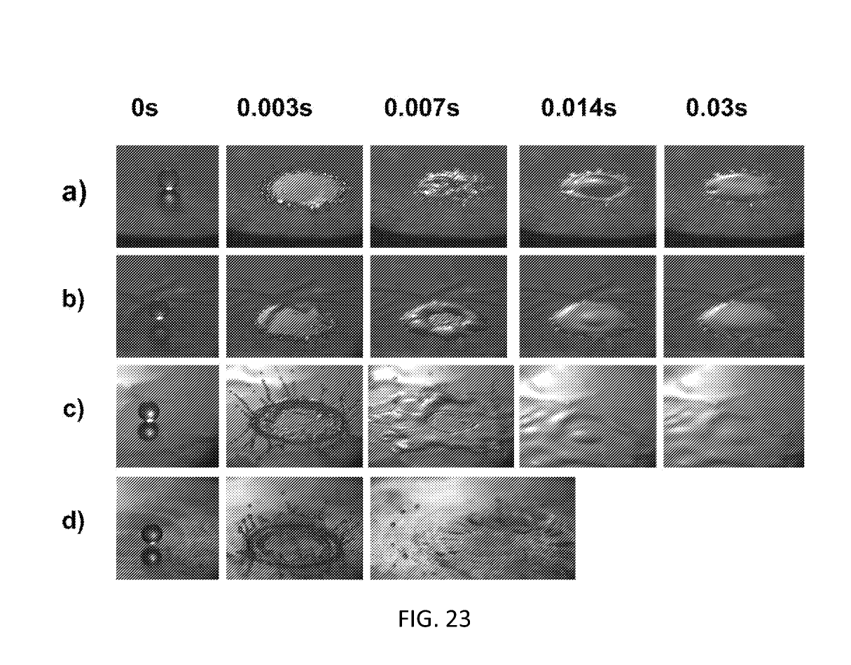

FIGS. 23A-D illustrate experimental results for drop impacts onto wet PAN nanomats in comparison with the results for impacts onto a dry nanomat, as well as onto a wet uncoated copper substrate. The impact onto the dry PAN nanomat leads to development of fingers without any trace of corona splash. The impact onto the wet saturated nanomat exhibits only very short fingers around the splat circumference. The spreading diameter is about the same in both cases. With a free water film at the nanomat surface, the situation significantly changes: drops splash at much lower impact velocities than on the dry PAN, and corona splash appears. The behavior is similar to an impact on a water film on pure uncoated copper target. It is clear that in this scale of roughness and liquid film thickness, splashing on liquid films is hardly affected by the material structure beneath it.

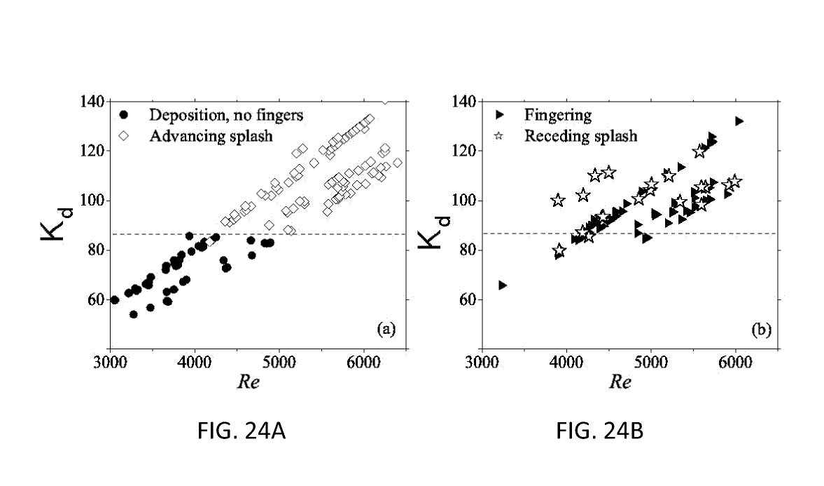

It is impossible to determine definite thresholds for impact conditions corresponding to specific impact outcomes. In fact, a range of impact conditions can be identified in which several types of outcomes can occur with some probability for the same impact conditions. This is explained by the fact that fingering and advancing and receding splashes are the results of an instability, which is initiated by the initial perturbations of drop surface and which cannot be completely controlled in the experiment. In FIG. 24 the results of the observations of various impact outcomes are shown in the threshold region. In an attempt to generalize the results, the diagram is shown for two independent dimensionless parameters: the Reynolds number, Re=ρDV₀/μ and the well-known splashing parameter K_{d}=[D³V₀⁵ρ³/(μσ²)]^{1/4} where ρ, μ, and σ denote liquid density, viscosity and surface tension, and D and V₀ the drop diameter and normal impact velocity. FIG. 24 represents a cumulative plot of the outcomes of drop impact on a PAN nanofiber mat with a thickness of about 200 μm, porosity of about 90-95%, and roughness R_{Z} of 8 μm measured over 1 cm² in the impact region. The data were acquired using the two variations of the experimental setup depicted in FIG. 21. The range of drop diameters in the experiments was from 0.1 to 3.5 mm, and the range of the impact velocities was from 0.4 to 3.6 m/s.

The setup of FIG. 21B produced oblique impacts of secondary droplets. In such cases, only the normal velocity component was used to calculate K_{d}. FIG. 24 combines data for normal impacts of biggest and smallest drops as well as oblique impacts of secondary intermediate droplets based on K_{d}, calculated using only the normal-to-the-surface velocity component. The results for both types of impacts regarding threshold and splashing morphologies are in good agreement in the complete pattern.

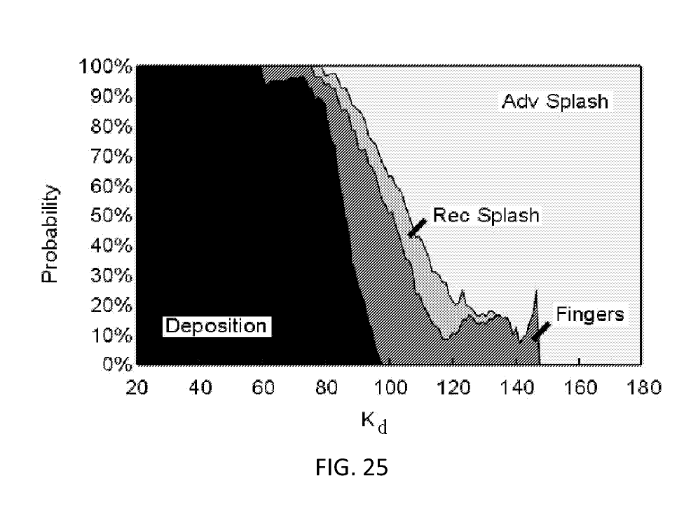

The dimensionless number K_{d} allows a clear delineation of the domain with respect to drop deposition without fingers and advancing splash (FIG. 24A). However, as is shown in FIG. 24B, in a certain parameter domain, various impacts with seemingly the same parameters can produce various outcomes (fingering and receding splash) with a certain probability. The corresponding probability chart for various outcomes as a function of K_{d} number is shown in FIG. 25.

It has previously been shown that the drop splashing threshold for a flat smooth substrate corresponds to K_{ds}=57.7. In the case of drop impact onto a nanomat the threshold value of K_{ds} separating deposition without fingers and advancing splash is higher, approximately K_{ds}=87, which indicates that the nanofiber coating of the target surface suppresses advancing splash.

The receding splashes, in which secondary drops are formed in receding fingers, were mostly seen in conjunction with the advancing splash and seldom observed as the sole splash phenomenon on nanomat surfaces. The rarity of the receding splash outcomes can be explained by the properties of the nanomat surface. Namely, a large contact angle hysteresis characteristic of nanomat surfaces renders liquid on the surface practically immobile and requires a large amount of energy for drop separation from a finger. However, if a drop possesses the required critical energy, it will likely be separated during the advancing splash stage.

Another observation is that occasionally a drop can eject a secondary tiny drop upon impact that is later intercepted by a moving finger originating from the primary drop. In such cases, no secondary drops are ultimately lost, which means that such events are not considered to be splash. The cumulative mass of the splashing tiny droplets in an advancing splash (with droplets leaving the surface) was about 1-2% of the primary drop mass, which was evaluated by measuring diameters and the number of such droplets.

The experiments with drop impacts onto example PCL nanomats showed that the splashing threshold is close to that of PAN. These experiments also showed that after drop impact, water typically penetrates into the example PCL nanomats, even though formally they are non-wettable based on the static contact angle of water on PCL films. Example PCL nanomats with embedded CB nanoparticles possessed an increased roughness and thus showed an earlier splashing.

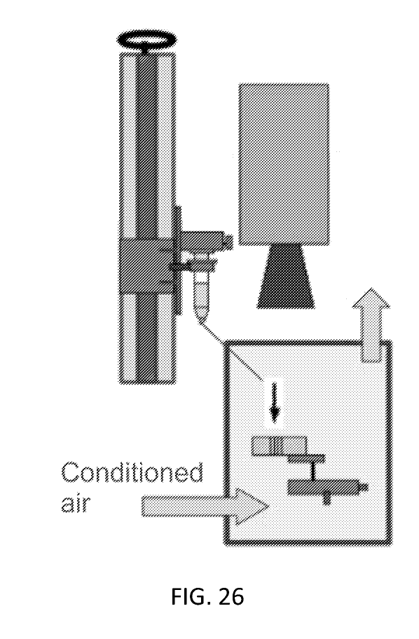

Additionally, the phenomena that occur inside example nanomats were studied. An experiment was performed to measure the rate of water spreading inside example nanomats (parallel to the underlying substrate surface). The experimental setup is shown schematically in FIG. 26. Measurements were performed in atmosphere with controlled humidity of the surrounding air. In all the experiments, drops of about 2 mm were dripped from about 10 cm height onto the nanomat surface to ensure similar initial conditions and impact parameters below the splashing limit. For observations in this experiment, a digital video camera with the frame rate of 30 frames per second was used.

The refraction indexes of the nanofibers and water are such that if a certain moisture level is reached in the example nanomat, it becomes transparent and the underlying darker copper surface becomes visible through the nanomat. This allows observation of slow water spreading inside nanomats.

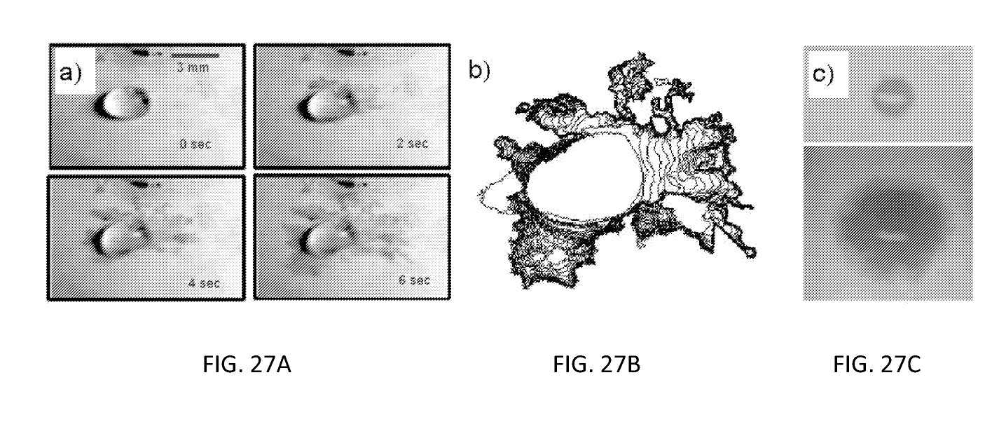

The captured images were used to characterize the growing dark area visible through the transparent nanomat spots (FIGS. 27A-C). In particular, in several cases (FIG. 27B) the wetted nanomat areas are rather fractal-like looking, and therefore their areas were determined using pixel-by-pixel counting and characterized by an area-equivalent radius. It is emphasized that FIG. 27B shows the worst case of the fractal-like spreading, and many images of the spreading process were quite circular (FIG. 27C). One measured pixel had a size corresponding to about 10 μm. The accuracy is increased by averaging the successive video images. The dark (transparent) spots were observed and also measured under different angles, to show that optical artifacts do not influence the results.

The darker areas have not been observed on the targets coated with nanocomposite nanomats: PCL with the embedded CB nanoparticles, the bi-layer coating (PCL over PAN), and some of the PCL nanomats. Water spreading in such mats could not be detected with the method used. Also, in the case where PCL or PAN nanomats were too thick, the observation method was inapplicable. Some areas stayed non-transparent throughout the whole spreading process, even though they were already surrounded by transparent areas, which corresponds to large differences in moisture concentration in nanomats. In such cases, the wet region inside example nanomats was more three-dimensional than two-dimensional. With two-layer nanomats (PCL over PAN) even for very thin mat thicknesses, spreading could not be observed. The drop above the surface was not distinguishable from a similar drop on pure PCL.

Only in the case of two-dimensional propagation of moisture could measurements be carried out with PAN nanomats, with the 100-200 μm thickness being the best for observations. For non-wettable PCL, there were PCL nanomats that showed water suction similar to PAN nanomats. However, there also were PCL nanomats that did not intake any water. This two-fold nature of water-PCL affinity might be related to the possible absorption of water at the carbonyl sites of the ester groups in PCL via hydrogen bonding.

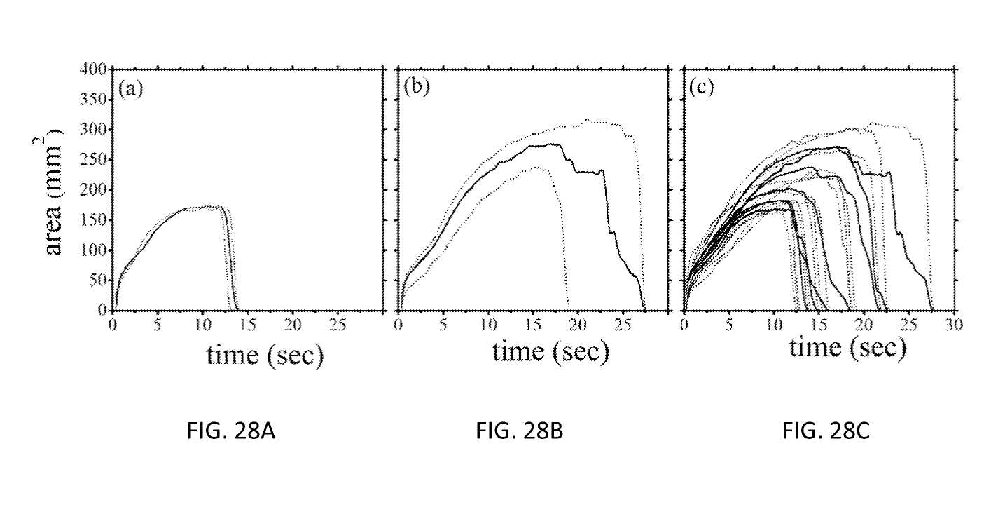

The experimental data for the wetted area in 100-200 μm thick PAN nanomat is plotted in FIG. 28 versus time for a range of humidity levels in the surrounding air. Three distinct stages of water-nanomat interaction can be distinguished. The first one, which lasts the first few milliseconds after impact, is the fast inertia-dominated spreading. Due to the short duration, the first stage is not recognizable in the graphs in FIG. 28, which is why the curves in FIG. 28 raise in a burst-like manner at the very first moments. The subsequent stage of the wettability driven wetting of the nanomats in FIG. 28 produces gradually raising lines. The spreading-wetted spot then reaches a plateau value. After that, the method used could not detect any additional spreading inside the nanomat (which might be still presept), and the observations were ceased. A subsequent drying of the wetted spot does not proceed as a receding de-wetting, but rather as a simultaneous “bleaching” of the whole wetted spot until the detection threshold is reached.

The plots in FIG. 28 show that for low humidity values the differences between the extreme values of the wetted area were insignificant, while they strongly depend on the humidity level for the high humidity levels. For these values, the differences between the time needed for the observable maximum spreading for the three curves in b) (81% humidity) were large, while in a), for low humidity of 7%, the differences in time were negligible. At the intermediate spreading stage the slopes of all curves are very close to each other.

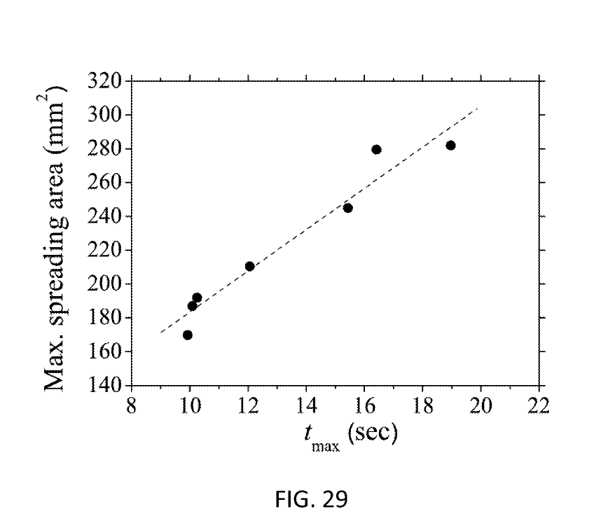

Despite the fact that humidity affects the value of the maximum visible radius of the wetted spot, it almost does not influence the rate of spreading. It can be assumed that the moisture spreading stage is nearly unaffected by evaporation into surrounding air, whereas evaporation starts to play an important role at the later stages, corresponding to the maximum wetted spot. The maximum wettability driven spreading observed and the time needed to achieve the maximum spreading are plotted in FIG. 29 for the entire humidity range. Each point in this graph corresponds to different humidity levels. The linear dependence shown is in agreement with theoretical predictions.

Thus, it was demonstrated that drop impacts on example electrospun nanomats almost instantaneously result in spread-out wetted spots over the surface, which practically neither recede or bounce. In the following stage wettability driven sideways water spreading inside partially wettable nanomats begins, which can last minutes, and in some cases the wetted area inside the mat looks similar to fractals. Prompt, advancing and receding splashes play a secondary role, with mass losses due to them on the scale of 1-2%. Receding fingering is practically completely suppressed.

The example electrospun nanomats in this experiment have pores of the order of 5 micron and porosity of the order of 90-95%. In the case of small pores, both wettability-driven penetration and dynamically-assisted accumulation of kinetic energy for penetration are much stronger than for microscopic and macroscopic fiber mats, for instance. Therefore, water penetrates easier in the case of nanomats. Also, nanomat porosity is so high that the example nanomats can take more water per unit volume compared to mats of microscopic and macroscopic fibers.

Further, the example nanomat thickness, of the order of 100-200 microns, is already sufficiently large for creation of an intact nanomat coating on a substrate with high capability of pinning the contact line of a spread-out drop. On the other hand, the nanomat thickness of the order of 100-200 microns is sufficiently small to deliver practically all water into a direct contact with the underlying substrate. Thicker nanomats can be less effective for spray cooling, since some water can stay on fiber surfaces, and evaporate there without reaching the substrate. Macroscopic and microscopic fibers make much thicker mats and thus may not deliver water directly to substrates, which is detrimental from the cooling point of view.

### Metalized Nano-textured Fiber Coverings

The texture of the example nanofiber coverings (e.g., nanomats) facilitates penetration of the coolant liquid (e.g., water, coolant, refrigerant, etc.) into their pores and simultaneously prevents receding motion of the contact line of spread-out drops, as well as eliminates bouncing. All of these phenomena are greatly beneficial for drop or spray cooling through example nanofiber coverings.

In certain example embodiments of the invention, further enhancement of drop or spray cooling through nanomats is provided by reducing the smoothness of the individual fibers on the nanoscale. This is achieved in example embodiments by making the nanofibers rougher, and preferably as rough as possible, by metalizing the nanofibers to provide a metal layer on the nanofibers that is rougher on the nano-scale. In particular example embodiments, non-woven (e.g., electrospun) nanofibers deposited on high-heat flux surfaces are electroplated to facilitate their cooling. The nanomats can otherwise be made of the same geometry of the nanomats described above.

Electroplating is a process that coats conductive or semi-conductive objects with a thin metal layer. The process uses an electrical current to reduce cations of a desired metal from a solution. It is used to deposit various metals on targeted surfaces, and can be shaped to cover the surface. The electroplating process is technologically stable and attractive for growing thin films and/or nanostructures with potentially superior thermoelectric and microelectronics properties. Thus, electroplating is used in some example embodiments to provide the metal layer on the nanofibers. However, other techniques, such as but not limited to attaching with glue, epoxy, etc., can be used to provide the metal layer.

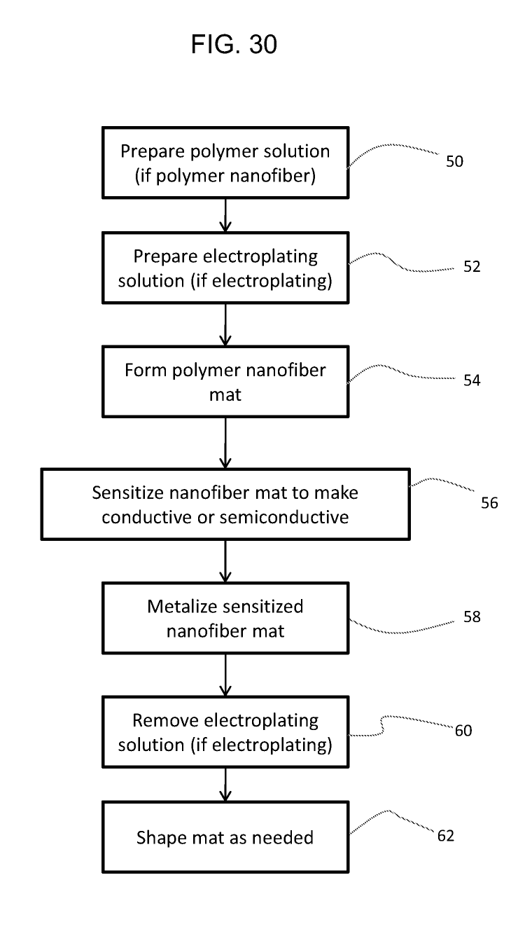

FIG. 30 shows an example process for providing metalized nano-textured fiber coverings (e.g., mats) according to an embodiment of the present invention. A polymer or non-polymer, preferably non-woven (e.g., fiber mesh), nanocovering (e.g., nanomat) is prepared. In a preferred embodiment employing a polymer nanofiber mat, a polymer solution is prepared (step 50) for electrospinning. Example polymers are described above, and a particular nonlimiting example polymer solution used in experiments described below is PAN in dimethylformamide (DMF). However, in other embodiments, non-polymer materials may be used for the nanofiber coverings, as described above, so long as the material is capable of being sensitized to be conductive or semi-conductive, and is sufficiently stable. As with the non-metalized mats, a preferred nanofiber mat to be metalized is a porous permeable material composed of individual non-woven polymer nanofibers, which are randomly oriented in the mat plane.

If electroplating is employed for the metallization, an electroplating solution is also prepared (step 52). The particular metal used in the electroplating solution can vary, but nonlimiting examples include copper, silver, nickel, and gold, or a combination, though copper is preferred. Other metals are possible, so long as they are conductive, have a melting point above the maximum operating temperature of the micro component surface to be cooled, and can be formed to make a rougher (“bumpy”) surface on the nanofibers. Methods for preparing the electroplating solution will vary according to the metal used, and nonlimiting example techniques for copper, silver, gold, and nickel are described below.

The nanofiber covering (e.g., mat) is formed (step 54), for instance using the techniques described above. In an example method, to form the nanofiber mat, the polymer solution is electrospun onto a surface. The surface can be the surface of the micro component to be cooled or another surface, as explained above. Nonlimiting example electrospinning methods and conditions are described above. A standard electrospinning setup can be used. In other embodiments, the nanofiber covering is formed using other deposition methods to provide a non-woven (or in other cases patterned) covering. If the mat is formed directly on the micro component surface, the mats may adhere to the surface during forming. Also, the mat can be formed and electroplated separately and then be deposited on the micro component surface.

For facilitating the metallization (e.g., electroplating), the nanofiber coverings are sensitized (step 56) to provide a conductive coating on the covering, making the nanofibers on the covering conductive or semi-conductive. In an example embodiment the formed nanofiber mats from step 54 are sputter-coated with a conductive coating, such as but not limited to Pt—Pd or any other conducting material (metal or alloy). Other techniques are possible for sensitizing the nanofiber mats, such as, for example, dip coating, PVD, CVD, etc. The sensitized nanofiber mats are then metalized (step 58), such as by immersing the sensitized nanofiber mats in the electroplating solution and electroplating the mats. The mats serve as a cathode, and an anode can be provided, for instance, by a metal substrate or in other ways. Example electroplating conditions are described in example experiments herein, though the present invention is not intended to be limited to the particular electroplating steps or conditions described. In some example embodiments the metallization process causes the nanofiber mats to adhere (or further adhere) to the surface, depending on the particular metal and surface chosen. However, an adhesion layer can be provided between the metalized nanofiber mats and the micro component surface if needed. Nonlimiting example thicknesses for the rougher metal layer are between 5 nm and 500 nm.

The nucleation and crystal growth modes of metal electrodeposits on the nanofiber mats during the electroplating step (step 56) play a significant role in development of nano-texture. Particularly, when the nucleation rate is higher than the crystal growth rate, a smooth metal coating will be obtained. On the other hand, if the crystal growth rate appears to be faster than the nucleating rate, a rough metal surface can be obtained.

There are many ways to control nucleation and crystal growth rates. This can be achieved, for example, by decreasing the rate of chemical reaction which can be done by decreasing the reactant concentrations, temperature control of the system, forming specific intermediates during electroplating, etc. Other methods of controlling the nucleation and/or crystal growth rates will be appreciated by those of ordinary skill in the art.

As a result of decreasing the rate of chemical reaction, the nucleation rate can be slowed down, while by increasing the electric current density, the crystal growth rate can be increased correspondingly. In preferred embodiments, slowing down the nucleation rate and increasing the crystal growth rate result in a rougher nano-texture for the metalized nanofiber mats, increasing their cooling efficacy.

If electroplating is used, the electroplated nanofiber mats are removed from the electroplating solution, and the electroplating solution is removed (step 60), such as by immersing the mats into a formaldehyde solution and rinsing with deionized (DI) water. The mats can be shaped (step 62), e.g., cut, as desired to cover surfaces of the micro component.

The metalized nanofiber mats can be employed for drop or spray cooling using the systems (such as that shown in FIG. 3) and methods described for earlier embodiments. No special adjustments of such systems are needed, albeit drop-on-demand arrays of certain frequencies might be preferable. In any case, the rougher nano-texture provided by the metalized nanofiber mats improves cooling efficiency for drop or spray cooling.

Experiments to demonstrate example embodiments of the invention will now be discussed. Artisans will appreciate broader aspects of the invention from the experiments. In the experiments below, nonlimiting example metalized nanofiber mats were prepared and tested for their cooling capabilities on example surfaces for drop cooling. Heat removal rates up to 0.6 kW/cm² are provided by the example metalized nanofiber mats, though even higher heat removal rates are possible.

### Experiment 3

### Fabrication of Metal-plated Nanofiber Mats

Materials. Polyacylonitrile (PAN; M_{w}=150 kDa) was obtained from Polymer Inc. N-Dimethyl formamide (DMF) anhydrous-99.8%, sulfuric acid, hydrochloric acid, copper sulfate, formaldehyde, silver nitrate, potassium hydroxide, ammonium hydroxide, nitric acid, nickel sulfamate, boracic acid, sodium hydroxide, triammonium citrate, potassium aurochlorate, and sodium sulfite were obtained from Sigma-Aldrich. Copper plates obtained from McMaster-Carr were cut into 1″×1″ square pieces used as substrates. The substrates were polished and cleaned with acetone by sonication prior to use.

Preparation of Solutions. For electrospinning, 12 wt % PAN solution in DMF was prepared. For electroplating the solutions were prepared as follows: (i) For electroplating copper, sulfuric acid (5 g), hydrochloric acid (0.5 g), copper sulfate (16 g) and formaldehyde (10 g) were mixed with 100 mL of deionized (DI) water to prepare a copper plating solution. (ii) For electroplating silver, silver nitrate, (0.5 g) and potassium hydroxide (0.25 g) were mixed with 5 mL DI water separately. Then these two solutions were mixed with ammonium hydroxide (1.25 mL) to prepare solution A. Sugar (2.25 g), nitric acid (0.1 mL) and 25 mL DI water were mixed and boiled to prepare solution B. Then, solution A and cooled solution B were mixed before the silver plating process was started. (iii) For electroplating nickel, nickel sulfamate (40 g) and boracic acid (3 g) were mixed with 100 mL of DI water. Then the solution pH was adjusted to 4.5 by adding a proper amount of sodium hydroxide solution. (iv) For electroplating gold, triammonium citrate (10 g) and potassium aurochlorate, KAuCl₄, (0.25 g) were mixed with 50 mL DI water. The solution was stirred until the potassium aurochlorate salt was fully dissolved. Then, sodium sulfite (3 g) was added to the solution. The initially opaque solution became transparent after the addition of sodium sulfite.

Electrospinning and Sensitization of Polymer Nanofiber Mats. Polymer nanofiber mats were prepared by electrospinning PAN solution using a standard electrospinning setup. Randomly oriented nanofibers were collected on thin copper substrates. Fibers were electrospun for 5-7 minutes, while keeping the flow rate of 0.8 mL/hr and the electric field about 1 kV/cm, which resulted in the nanofiber thicknesses of the order of 20-30 μm. The nanofiber mats adhered to the copper substrates and were used as templates for the further electroplating.

For the electroplating nanofiber mats had to be sensitized to make them conducting. For that purpose the nanofiber mats were sputter-coated with Pt—Pd to a thickness of 15 nm by using Cressington Sputter Controller.

Electroplating. For electroplating the sputter-coated nanofiber mats were immersed in one of the above mentioned solutions (i)-(iv) and served as a cathode. A bare copper substrate served as an anode. A laboratory electroplating station EPS-10 (Model-2009) with a cathode rotating stand was used for electroplating nanofiber mats.

Electroplating of Copper. For copper plating the electric current density was kept at 100 mA/cm² for 3 minutes to form a fine coating. Then, the electroplated sample was taken out from the electroplating bath. After that, the copper-plated nanofiber mat was immersed into 10% formaldehyde solution for 5 minutes, and then rinsed twice by DI water. Note that the copper-plated nanofiber mat was copper-bonded to the copper substrate.

For electroplating of copper, sulfuric acid was added to the electroplating bath to improve conductivity and the process efficiency, which also could prevent formation of the oxide layers. During the electroplating process, copper is dissolved at the anode with the participation of sulfuric acid, and the copper anode is in the solubility equilibrium with the dissolved CuSO₄. Copper is lost from the electrolyte during electroplating, and can be replaced by copper dissolved from the anode. Therefore, copper concentration in the electrolyte should be constant during this example electroplating process. In this process, not only Cu²⁺, but also Cu⁺ ions will be dissolved from the anode material. After the deposition was over, the electrodes and the electrolyte were stored separately from each other to avoid any change in the electrolyte copper concentration in future electroplating on nanofibers. For the copper sulfuric electroplating bath used in this experiment, the redox reactions were as follows:

Cathode: Cu²⁺+2e⁻→Cu

Anode: Cu+2e⁻→Cu²⁺

Electroplating of Silver. For silver plating the electric current density was kept at 100-150 mA/cm² for 5 minutes and then the sample was taken out from the electroplating bath. After that, the silver-plated nanofiber mat was immersed into 10% formaldehyde solution for 5 minutes, and then rinsed twice by DI water. Because the nanofiber mat was deposited on the copper substrate, the copper-silver bonding formed here is weaker than the copper-copper bonding formed in the copper-plating experiments. That is caused by differences in metal crystal structures, as well as in the electro-chemical potentials of different metals.

For silver electroplating in this experiment the following reactions were taking place in the electroplating bath:

AgNO₃+KOH→AgOH+KNO₃

AgOH+2NH₃→[Ag(NH₃)₂]⁺+OH⁻ (Tolien's Reagent)

Cathode: [Ag(NH₃)₂]⁺+e⁻→Ag+2NH₃ (aq)

Anode: Ag→e⁻+Ag⁺

Electroplating of Nickel. For nickel plating the electric current density was kept at 50 mA/cm² for 5 minutes and then the sample was taken out from the electroplating bath. After that, the nickel-plated nanofiber mat was immersed in 10% formaldehyde solution for 5 minutes, and rinsed twice by DI water. The nickel-copper bonding formed here is weaker than the copper-copper bonding formed in the copper-plating experiment, similarly to the silver plating mentioned above.

For nickel electroplating using nickel sulfamate, the following redox reactions were taking place in the electroplating bath:

Cathode: Ni²⁺+2e⁻→Ni

Anode: Ni→2e⁻+Ni²⁺

Electroplating of Gold. For gold plating the electric current density was kept around 50 mA/cm² for 10 minutes and then the sample was taken out from the electroplating bath. After that, the gold-plated nanofiber mat was immersed in 10% formaldehyde solution for 5 minutes, and rinsed twice by DI water. The gold-copper bonding formed here is weaker than the copper-copper bonding formed in the copper plating experiment, similarly to the silver and nickel plating mentioned above.

For the gold plating, the following reactions were implemented in the electroplating bath:

SO₃²⁻+2OH→SO₄²⁻+H₂O+2e⁻

AuCl₄⁻+2e⁻→AuCl₂⁻+2Cl⁻

AuCl₂⁻+2SO₃²⁻→[Au(SO₃)₂]³⁻+2Cl⁻

The overall reaction was:

AuCl₄⁻+3SO₃²⁻+2OH→[Au(SO₃)₂]³⁻+4Cl⁻+SO₄²+H₂O

and the redox reactions were:

Cathode: AuCl₄⁻+3e⁻→Au+4Cl

Anode: Au→3e⁻+Au³⁺

Experiments with Drop Impact on H of Nano-textured Surfaces

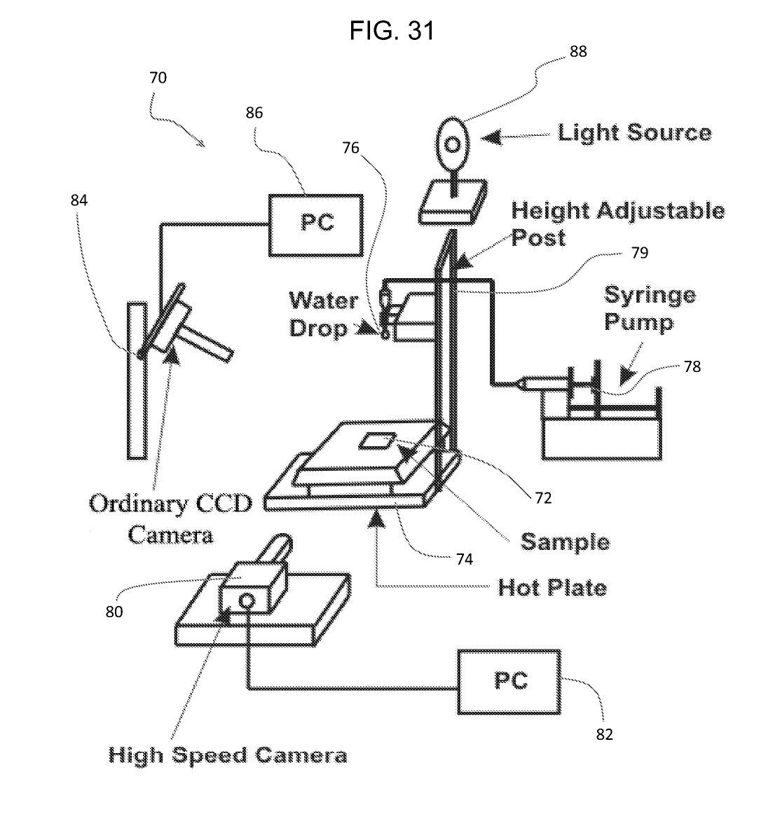

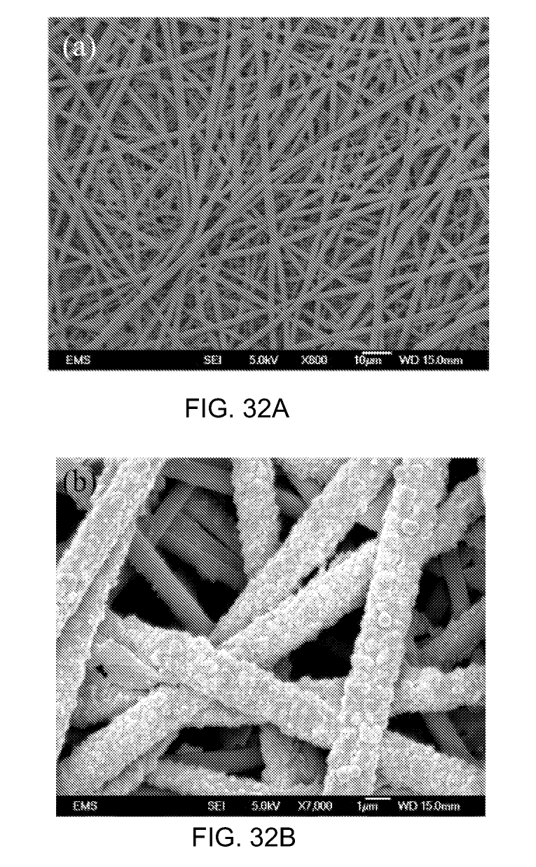

Drop Impact Experiments. For the investigation of drop impacts, three different variants of the experimental setup 70 depicted in FIG. 31 were used. In this setup substrates 72 were kept on a hot plate 74 at a constant temperature. Water 76 was supplied to the needle end using a syringe pump 78. As a result, a single drop had been growing at the needle edge, then disconnected and dripped due to gravity. After that, the pump 78 had been stopped. Water drops were dripped from a height, which could be varied via a height adjustable post 79. For visualization of drop impacts on metal-plated nanofiber mats, two cameras were used in the basic setup in FIG. 31. For high speed photography a Redlake Motion Pro camera 80 coupled to a PC 82 was used at a recording speed of 2000 fps, and for capturing top views an ordinary CCD video camera Pulnix 7M 84 coupled to a PC 86 was used at a recording speed of 30 fps. In the second variant of the setup, the low speed CCD camera 84 was removed and only the high speed CCD camera 80 was used. In the third variant of the setup, the low speed CCD camera 84 was used only. A light source 88 was also provided.

Calibration of Temperature on Hotplate. It is noted that the temperature on the display of the hot plate 74 is not exactly the same as that of the sample 72 on top of it. Therefore, measurements of the sample temperature were done separately and the calibration of the temperature versus that of the display is shown in Table 4. The thin copper substrates used in the experiments were covered by metal-plated nanofiber mats of thicknesses of about 30 μm. In this case the substrate steady-state temperature distribution is uniform and accurately represented by its base temperature measured by a thermocouple. The latter represents itself the whole sample temperature (including nanofibers) given in Table 4.

TABLE 4
Sample temperature versus display temperature.

| Display temperature (° C.) | Sample temperature (° C.) |
|---|---|
| 40 | 34 |
| 50 | 41 |
| 60 | 50.3 |
| 70 | 57.5 |
| 80 | 68.4 |
| 90 | 73.6 |
| 100 | 83.7 |
| 110 | 93.5 |
| 125 | 102.7 |
| 150 | 125.6 |
| 200 | 172.2 |

### Experimental Observations

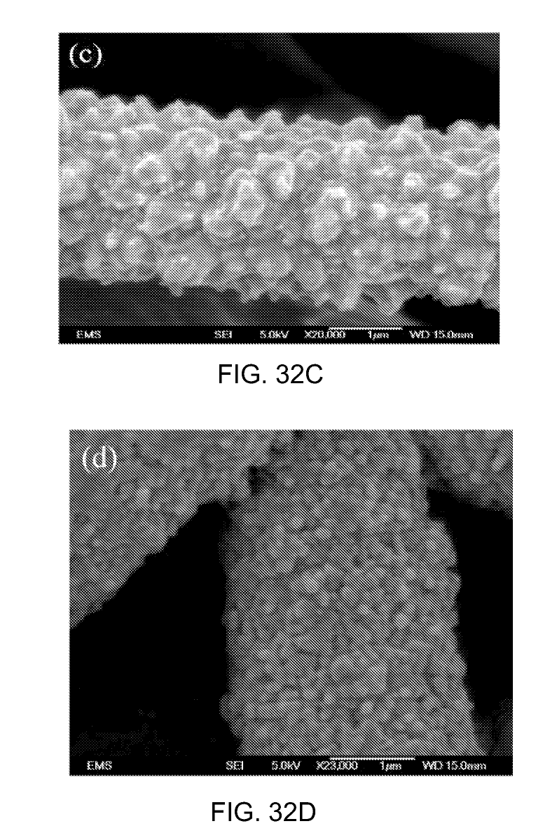

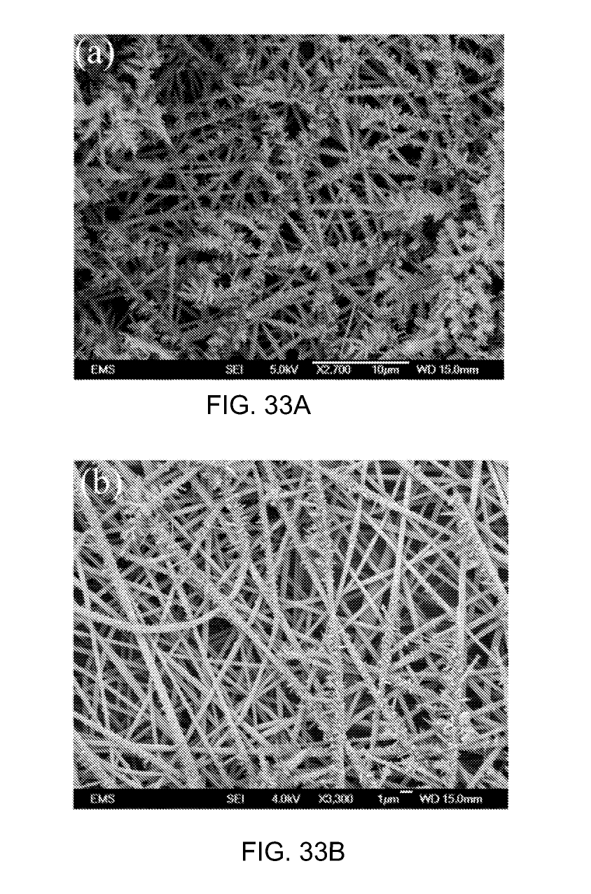

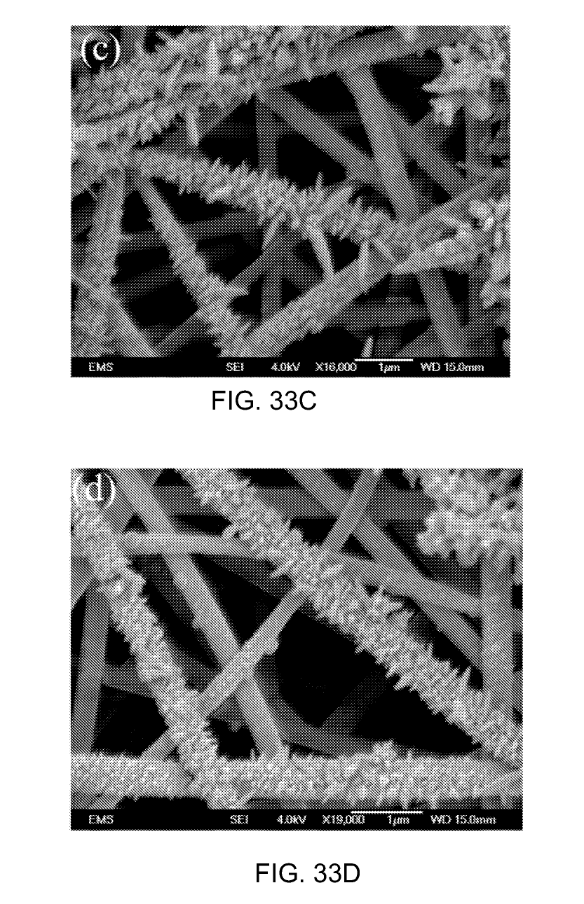

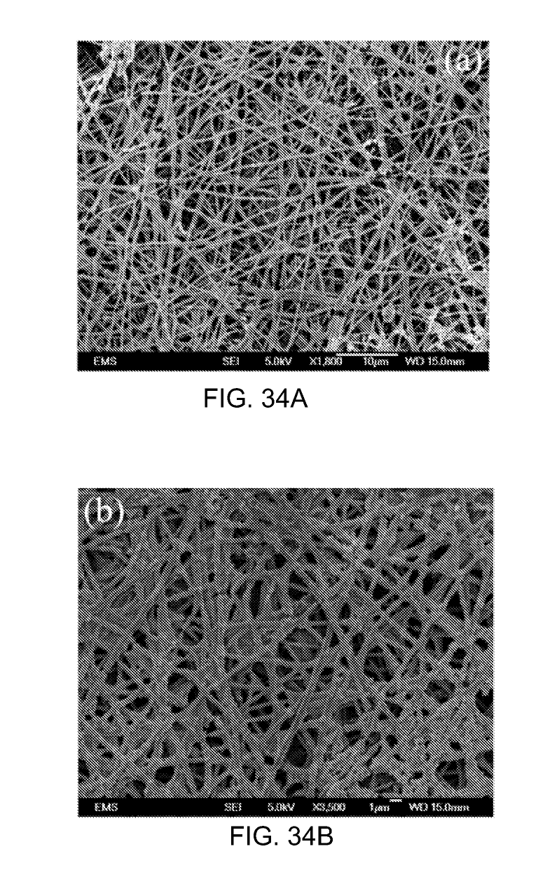

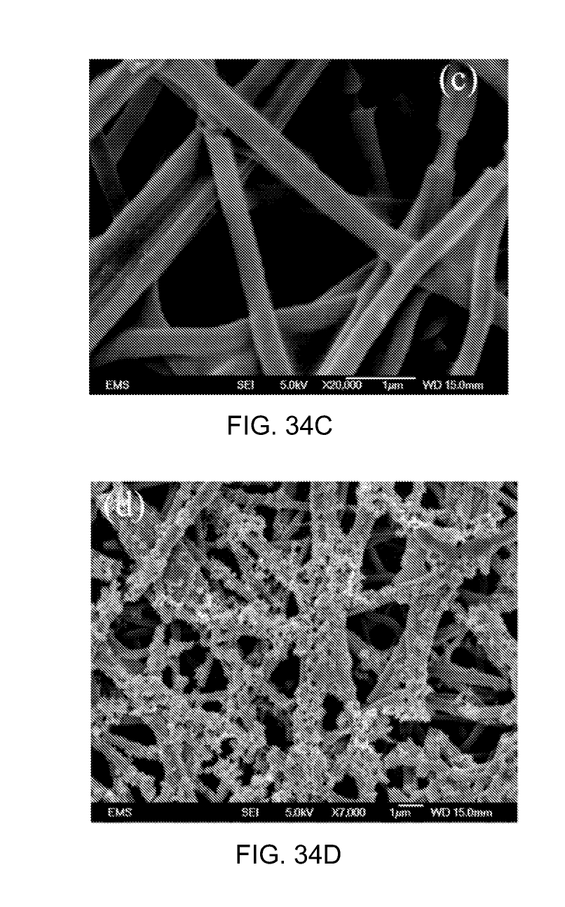

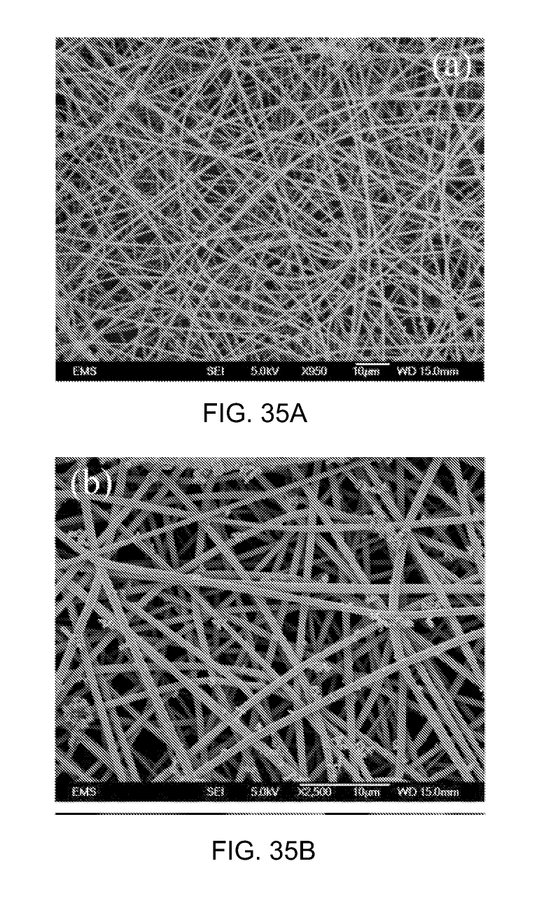

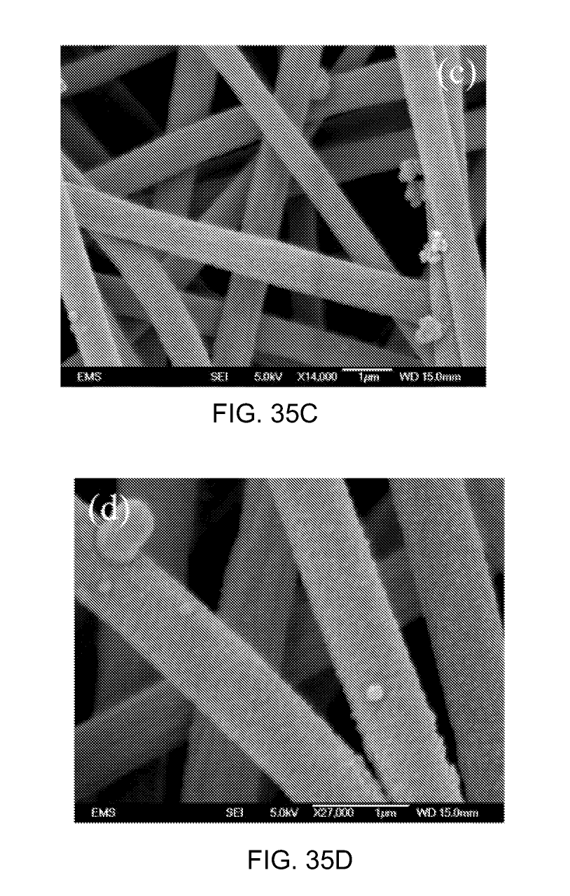

Metal-plated Nanofiber Mats. SEM images of the electroplated nanofiber mats are shown in FIGS. 32-35. All scanning electron microscopy of metal-plated nanofiber mats in these example experiments was performed using JEOL JSM-6320F with a cold emission source. The individual copper-plated fibers possess thorny (FIG. 32C) and grainy (FIG. 32D) nano-texture, which makes them reminiscent of the Australian thorny devil lizards. Silver-plated nanofibers are equally rough but show predominantly dendrite-like or cactus-like structures (FIG. 33). The nickel-plated nanofibers reveal an additional type of nano-texture, namely, the distinct domains of smooth and rough fibers (FIG. 34). In contrast to the other cases, gold-plated fibers are smoother and possess only infrequent spheroidal appendices or their small clusters (FIG. 35).

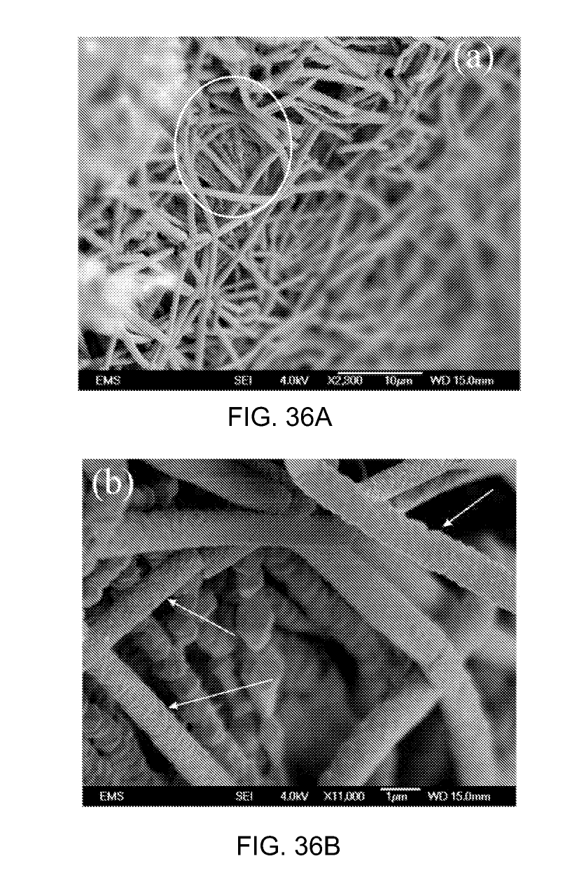

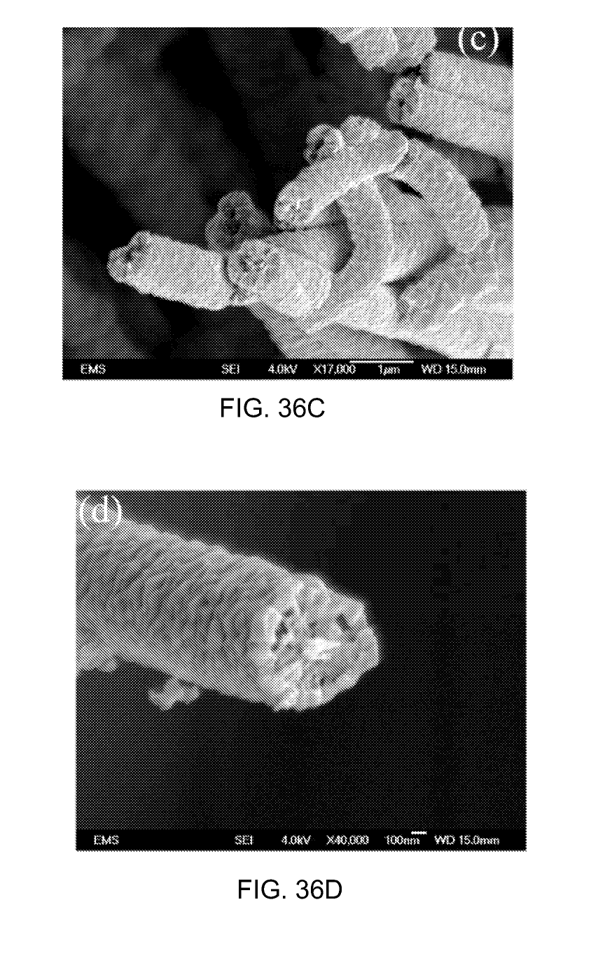

The comparison of the images with the same magnification (FIGS. 32C-32D, 33C-33D, 34C-34D and 35C-35D) shows that copper-plated fibers possess the roughest nano-texture uniformly. Moreover, even though only the upper layer of the nanofibers appears to be rough in FIGS. 32 and 33, this is only an artifact related to the electron beam focusing in SEM. The images of a cut copper-plated nanofiber mat in FIG. 36 show that the fibers at the mat bottom in contact with the underlying substrate are as thorny-devil-like as those near the mat surface in FIG. 32. Therefore, the fibers are rough throughout the whole mat depth.

Similarly, the nickel-plated fibers possess a mosaic of smooth and rough domains, and gold-plated fibers are practically smooth throughout the mat depth. The nucleation and crystal growth modes of metal electrodeposits have a vital bearing on the development of nano-texture. Generally speaking, when nucleation is faster than crystal growth, a smooth coating will be obtained. The nucleation rate depends on a number of factors, such as the rate of chemical reaction, temperature, the initial metallurgical state of the cathode, etc. For gold plating, the formation of [Au(SO₃)₂]³⁻ complexes makes the cathode polarization rate lower, which means that the nucleation is faster than the crystal growth. However, for copper and nickel, the reaction is “simple” and fast, which may lead to a higher cathode polarization speed and, thus, nucleation speed. In the case of the gold-plated nanofibers in FIG. 35 the formation of the visibly rough domains can be attributed to a high speed of the outward crystal growth of the deposit by continuous nucleation during the last step of the three-dimensional metal electrodeposition. In general, if the crystal growth is faster than the nucleating rate, one can obtain a rough surface, which is a desirable feature.

Surface Enhancement Factor. The surface enhancement factor α is defined as a ratio of the overall surface area including that of the fibers on a unit area of a substrate to that of the bare substrate. Note that in the general case the bare substrate used for comparison might be made of a different metal than the one coated with nanofibers, since in the experiments described herein the expectation is that the surface enhancement factor is a pure geometric parameter.

For the evaluation of the surface enhancement factor the following experiment was conducted. A water drop was dripped from a fixed height of 10.64 cm on either bare copper substrate or a copper substrate covered with copper-plated nanofiber mat. The bare substrate and the fiber-mat-coated substrate were kept at the same fixed temperature when drop evaporation was observed. In different experiments a fixed temperature was chosen from the range from 40° C. to 110° C. (the display temperature, which corresponds to 34° C. to 93.5° C. sample temperature) with a 10° C. step (the display temperature). The evaporation time Δt of water drops was recorded using the ordinary CCD camera. The thermal balances for a bare substrate and a nanofiber-coated substrate read

$$\begin{matrix}{LV}_{1} = \frac{{k}_{w 1}}{{δ}_{w 1}} Δ {TS}_{1} Δ {t}_{1} & ( 1 ) \\ {LV}_{2} = \frac{{k}_{w 2}}{{δ}_{w 2}} Δ {TS}_{2} Δ {t}_{2} & ( 2 )\end{matrix}$$

where subscripts 1 and 2 refer to a bare substrate and a nanofiber-coated substrate, respectively. Also, L is the latent heat of evaporation, V is the drop volume, k_{w} and δ_{w} are the thermal conductivity and thickness of a substrate, respectively, S is the wetted surface area, and ΔT is the excess temperature of the substrates relative to the room temperature.

The area S₂ can be represented as the sum of the wetted substrate area S₂₀ and the wetted nanofiber area on the substrate ΔS

S₂=S₂₀+ΔS (3)

In the experiments it was k_{w1}=k_{w2} and δ_{w1}=δ_{w2}, i.e. two substrates of the same material and thickness were used. Also, two drops were identical, i.e. V₁=V₂=3.053 mm³, which corresponds to the initial drop radius of 0.9 mm. Then, Eqs. (1)-(3) reduce to

$$α = 1 + \frac{Δ S}{{S}_{20}} = \frac{Δ {t}_{1}}{Δ {t}_{2}} \frac{{S}_{1}}{{S}_{20}} \qquad ( 4 )$$

The values of Δt₁, Δt₂ and S₁/S₂₀ measured experimentally are listed in Table 5 together with the surface enhancement factor α found from Eq. (4). The relative surface area of the nanofibers was determined from Eq. (4) as

$$\frac{Δ S}{{S}_{20}} = α - 1 \qquad ( 5 )$$

which is also presented in Table 5.

TABLE 5
Surface enhancement factor α

| | | | | | | Relative |
|---|---|---|---|---|---|---|
| | | | | | | surface |
| Temperature | | | | | | area of |
| (° C.) | Δt₁ | Δt₂ | | | | nanofibers, |
| Display/sample | (sec) | (sec) | Δt₁/Δt₂ | S₁/S₂₀ | α | ΔS/S₂₀ |
| 40/34 | 255 | 30 | 8.5 | 0.873 | 7.42 | 6.42 |
| 50/41 | 195 | 21 | 9.3 | 0.852 | 7.91 | 6.91 |
| 60/50.3 | 100 | 18 | 5.56 | 0.933 | 5.18 | 4.18 |
| 70/57.5 | 60 | 15 | 4 | 0.804 | 3.22 | 2.22 |
| 80/68.4 | 39 | 13 | 3 | 0.833 | 2.50 | 1.50 |
| 90/73.6 | 25 | 9 | 2.78 | 0.717 | 1.99 | 0.99 |
| 100/83.7 | 18 | 7 | 2.57 | 0.934 | 2.40 | 1.40 |
| 110/93.5 | 16 | 5 | 3.2 | 0.908 | 2.90 | 1.90 |

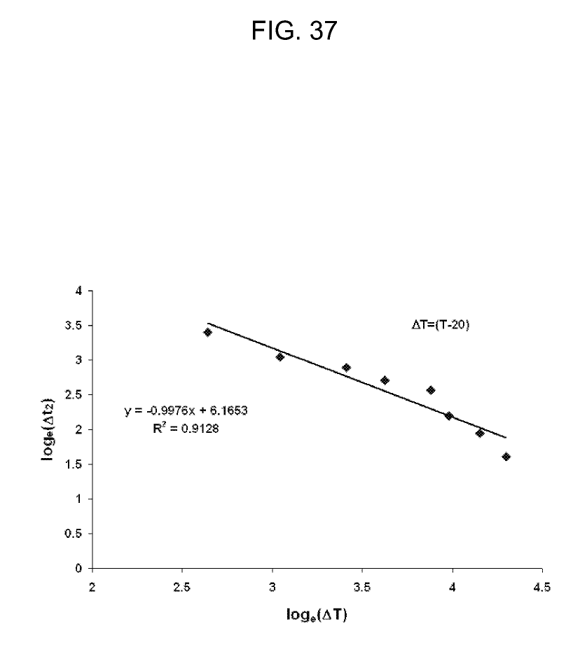

Note that the experimental data in Table 5 fully support Eqs. (1) and (2). Indeed, taking for the room temperature the value of 20° C. and taking the sample temperature from Table 4, one can plot the measured value of the evaporation time on metal-plated nanofiber mats Δt₁ versus ΔT. The result, plotted in FIG. 37, fully supports the linear dependence of Δt₂ on ΔT⁻¹ anticipated from Eq. (2).

The data in Table 5 and FIG. 37 show that at elevated temperatures the linear dependence of t₂ on ΔT deteriorates and the effective value of α decreases, which probably can be attributed to the effect of rapid evaporation and boiling inside the copper-plated nanofiber mat. Therefore, only the values at the lowest two temperatures are relevant to determine such purely geometric parameter as the surface enhancement factor α. Then, the surface enhancement factor due to the presence of nanofibers is in the range a α≈7.5-8.

Morphology of Drop Impact Cooling Through Copper-plated Mats. Copper substrates coated with metal-plated nanofiber mats, as well as bare copper uncoated substrates used for control, were located on a hot plate at different fixed elevated temperatures. Water drops released from different heights were used to locally cool them to evaluate the corresponding cooling rate. In these experiments the setup depicted in FIG. 31 was initially employed. A substrate coated with copper-plated nanofiber mat was placed on a hot plate at a fixed temperature of 150° C. (the display temperature corresponding to 125.6° C. of the sample). A single water drop of radius a₀=0.9 mm was dripped from various heights. The whole process (drop approach, spreading, and evaporation at the nanofiber mat) was captured simultaneously by the ordinary CCD camera (recording at 30 fps) and the high speed camera (at 2000 fps). The ordinary CCD camera recorded the process from top, whereas the high speed camera recorded the process from a side. Drops fell onto nanofiber mats from the following heights: h=3.55 cm, 6.15, 8.75, 11.15, 13.75 and 17.95 cm, which correspond to the impact velocities V₀=83.46, 109.85, 131.02, 147.91, 164.25 and 187.66 cm/s respectively, (evaluated as V₀=\sqrt{2gh}, where g is gravity acceleration).

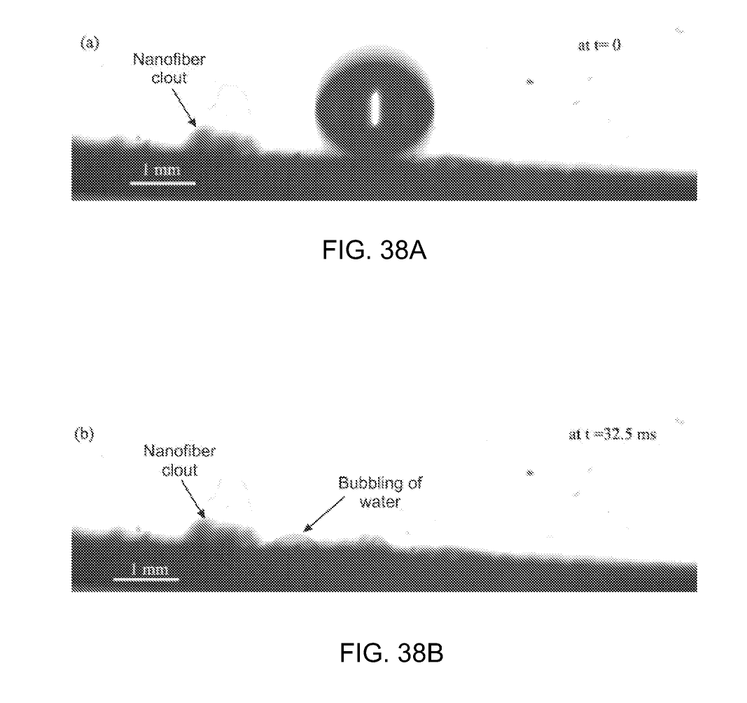

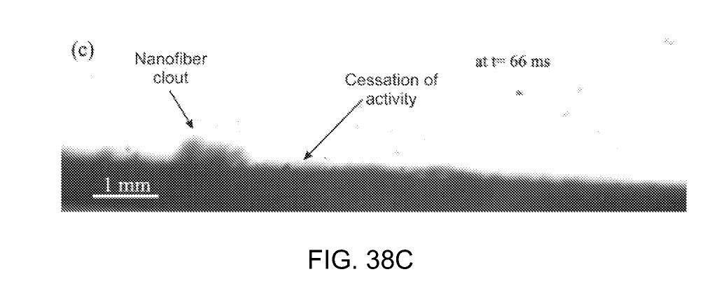

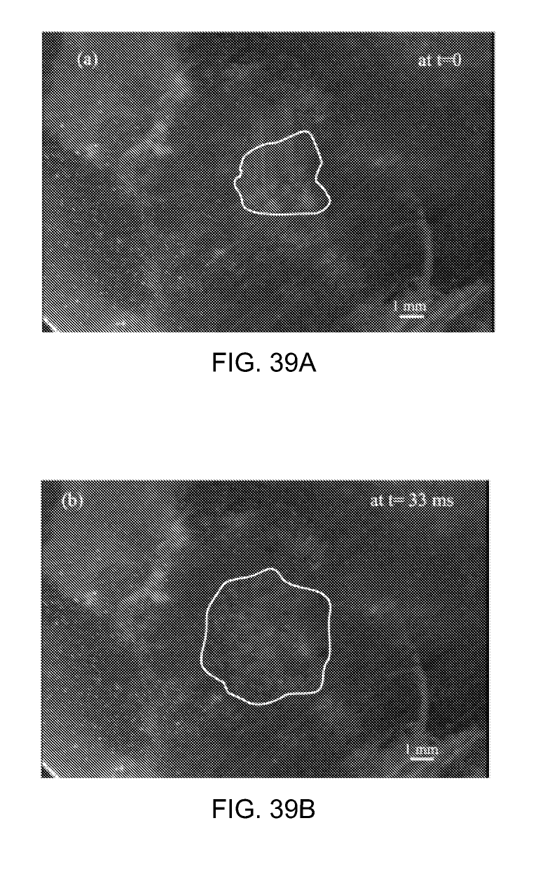

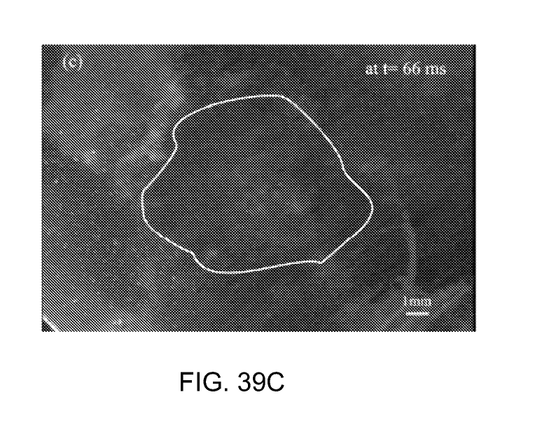

The top and side view images of drop impact from the height of 3.55 cm, spreading and evaporating on a copper-plated nanofiber mat are shown in FIGS. 38 and 39, respectively. FIG. 38A depicts the moment of drop impact (t=0) at the nanofiber surface. FIG. 38B shows that at the moment t=32.5 ms water boiling is visible at the surface, whereas FIG. 38C demonstrates that boiling seemingly ceased at t=66 ms and there is no visible activity at the surface anymore. In FIG. 39A the area surrounded by the white tracing contour corresponds to the projection of the oncoming drop onto the nanofiber mat surface. This image corresponds approximately to the top view of the situation similar to that of FIG. 38A. In FIG. 39B the area surrounded by the white tracing contour is still covered by water visible in the side view of the corresponding FIG. 38B. Water was either partially evaporated or penetrated into the copper-plated mat between the images in FIGS. 39A and 39B. In FIG. 39C the area surrounded by the white tracing contour is still wetted, even though the active boiling at the surface (and probably inside the mat) has already ended according to the corresponding FIG. 38C.

From that time on, the wet area begins rapidly losing its visible contrast, which probably corresponds to the ultimate drying. It should be mentioned that when the images recorded by the CCD camera for the longer times were analyzed, some minor contrast variations were observed for the next 4-5 frames, which corresponds to t=132-165 ms. However, the contrast variation was so small that no visible activity was recorded by the high speed camera in this time range. Therefore, it was concluded that the above-mentioned minor contrast variations resulted most probably from condensation of water vapor onto nanofiber mat, which followed the cessation of the cooling stage. Due to the low time resolution of the CCD camera used, it could not resolve the time frame t<33 ms in FIG. 39. However, FIG. 39 shows that the water drop impacted onto the surface between the FIG. 39A and FIG. 39B, which corresponds to 0≦t≦33 ms and that it fully evaporated sometime between FIGS. 39C and 39D, which corresponds to 66≦t≦99 ms. On the other hand, FIG. 38 shows that the activity at the surface of the nanofiber mat ceased at 66 ms, which is close to the time frame suggested by FIG. 39. Similar observations were done for drop impacts from the other heights.

Cooling Rates with Copper-plated Nanofiber Mats. The heat flux j was evaluated from the experimental data using the following expression: j=ρ(4πa₀³/3)(1−p)L/πa²Δt, where ρ is the liquid density, a₀ is the initial drop radius, a the full spread-out radius after drop impact onto nanofiber mat, L is the latent heat of evaporation of water, and Δt is the duration of drop evaporation. The above expression also involves the “atomization” volume ratio p. The value of p corresponds to mass lost due to “atomization” from the mat surface, which accompanied the evaporation process in some cases. The direct measurements of p are described below. Using the side view images, it is practically impossible to resolve the spread-out radius a. The top view images showed that the maximum spread factor ξ=a/a₀ for water drops on the copper-plated mats was close to ξ=2. Then, the values of the spread-out radius a (and thus, of ξ) were evaluated using the following widely used expression ξ=0.61(We/Oh)^{0.166}, where the Weber and Ohnesorge numbers are defined as We=ρ2a₀V₀²/σ and Oh=μ/(ρσ2a₀)^{1/2}, with μand σ being viscosity and surface tension of water. Such values of ξ correspond to the maximum spread-out on a surface at room temperature, and thus lead to an underestimation of the cooling rate j. Note also, that the evaporation time Δt and the “atomization” volume ratio p could be accurately evaluated from the side view images recorded by the high speed camera, therefore the top view images recorded by the CCD camera should not be used for this purpose.

The corresponding results for the spread factor ξ and the cooling rate j are presented in Table 6. The underestimated values of the cooling rate are close or exceeding the value of j≈0.57 kW/cm² (for the part related to the latent heat of evaporation here and hereinafter), which is an excellent value. No clear dependence of j on the impact velocity is visible in Table 6.

TABLE 6
The maximum drop spread factor and the cooling rates corresponding to
water drop impact on copper-plated nanofiber mats at 150° C.
(the display temperature corresponding to 125.6° C. of the sample).
No visible “atomization” was recorded, therefore p = 0.

| h | V₀ | Δt | | | j |
|---|---|---|---|---|---|
| (cm) | (cm/s) | (ms) | ξ | p | (kW/cm²) |
| 3.55 | 83.46 | 66 | 2.6 | 0 | 0.607 |
| 6.15 | 109.85 | 58 | 2.85 | 0 | 0.575 |
| 8.75 | 131.02 | 53.5 | 3.02 | 0 | 0.555 |
| 11.15 | 147.91 | 52.5 | 3.15 | 0 | 0.521 |
| 13.75 | 164.25 | 47 | 3.25 | 0 | 0.543 |

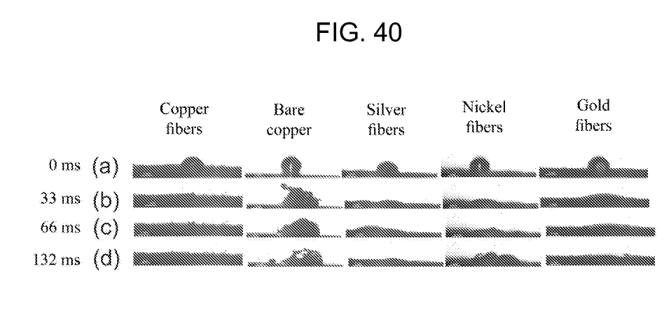

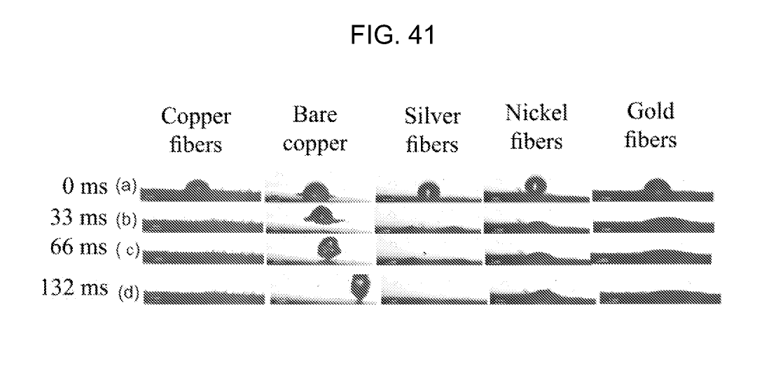

Comparison of Drop Impacts and Cooling Rates for Copper-plated, Silver-plated, Nickel-plated and Gold-plated Nanofiber Mats. Drop impact morphologies and the corresponding cooling rates through different metal-plated nanofiber mats (and a bare copper substrate used as a control) were studied at a fixed height of water drop release at h=17.95 cm. The latter corresponds to the drop impact velocity V₀=187.66 cm/s and the overestimated spread factor of ξ=3.407. The fixed hot plate temperatures were chosen as 125° C., 150° C. and 200° C. (the display temperatures corresponding to 102.7° C., 125.6° C. and 172.2° C. of the sample, respectively). Drop impact morphologies at different metal-plated nanofiber mats are shown in FIGS. 40-42, which correspond to 125° C., 150° C. and 200° C. (the display temperatures), respectively. It is clearly seen that on all metal-plated nanofibers water drop evaporates faster than on the bare copper substrate used for control. Moreover, at higher temperatures of 150° C. and 200° C. (the display temperatures corresponding to 125.6° C. and 172.2° C. of the samples, respectively) the water drop bounces back and levitates over the bare copper substrate, which corresponds to the Leidenfrost effect.

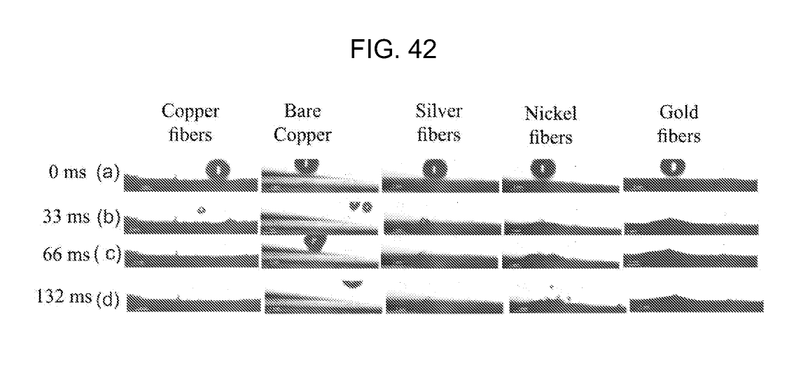

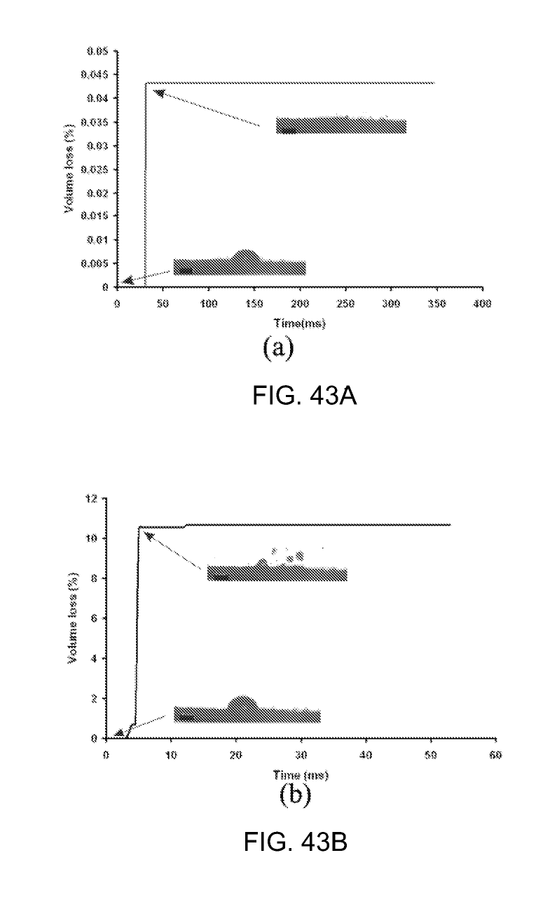

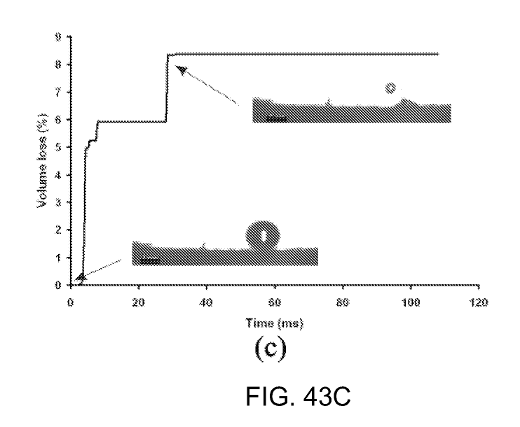

The comparison and description of the results for the different metal-plated nanofiber mats are facilitated by the values of the thermal diffusivities of these metals. The values of the thermal diffusivity have been previously derived elsewhere as follows: for copper α_{Cu}=1.1 cm²/s, for silver α_{Ag}=1.7 cm²/s, for nickel α_{Ni}=0.19 cm²/s and for gold α_{Au}=1.23 cm²/s. The most effective fibers yielding the fastest evaporation according to FIGS. 40-42 are the copper-plated fibers, with the silver-plated fibers being the second and producing close evaporation times. The highest efficiency of copper and silver could be expected based on their high values of the thermal diffusivity and highly developed thorny-devil-like or dendrite-like roughness depicted for these fibers in FIGS. 42 (copper) and 43 (silver). The fact that the nickel-plated fibers lag behind the copper-plated and silver-plated ones is not surprising given an order of magnitude lower thermal diffusivity of nickel compared to that of copper and silver, and the lower fiber roughness (cf. FIG. 34 with FIGS. 42 and 43). As shown in FIGS. 40-42, the gold-plated fibers lag far behind the copper-plated fibers, even though the thermal diffusivities of copper and gold are close. The latter suggest that thorny-devil-like copper-plated fibers are much more effective in drop cooling than the smooth gold-plated ones (cf. FIGS. 32 and 35) because the surface area of the former is dramatically higher than that of the latter. Gold-plated nanofibers yield evaporation time as long as that on the nickel-plated fibers (cf. Table 6), even though the disparity in the corresponding thermal diffusivities is of the order of one order of magnitude in favor of gold. Further, the evaporation times on metal-plated nanofiber mats are dramatically shorter than those reported before for the polymer mats. In particular, the shortest evaporation times measured in these experiments are about 400 times shorter than the shortest times previously reported for the comparable temperatures.

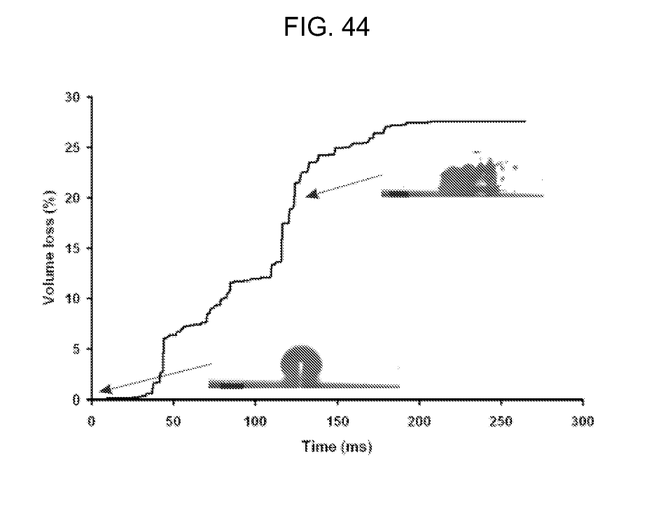

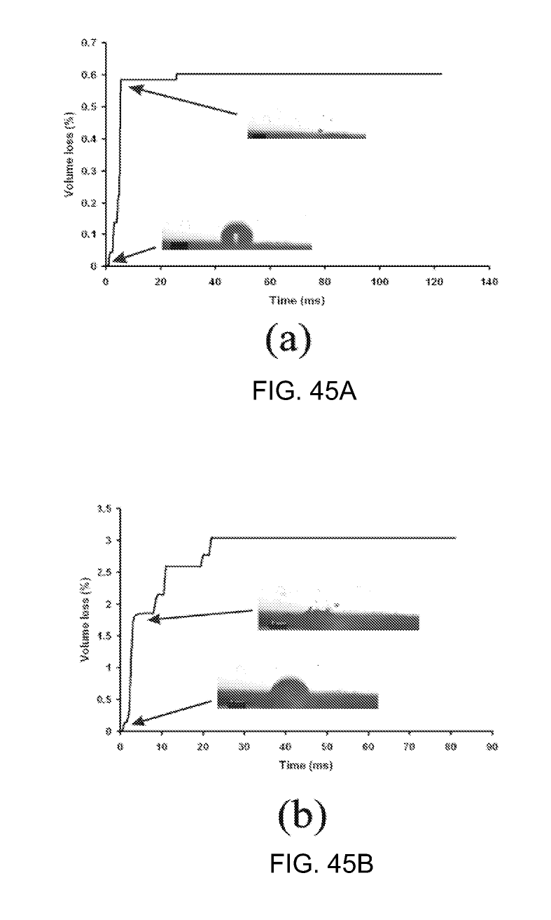

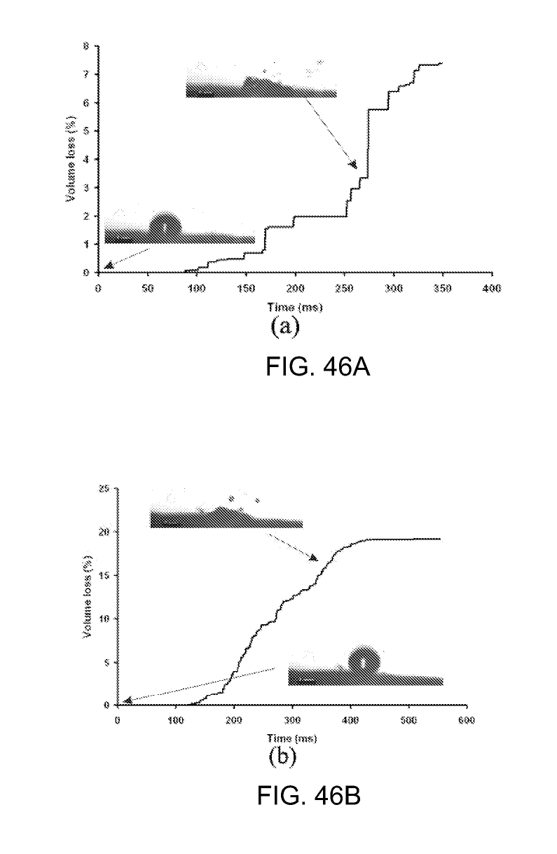

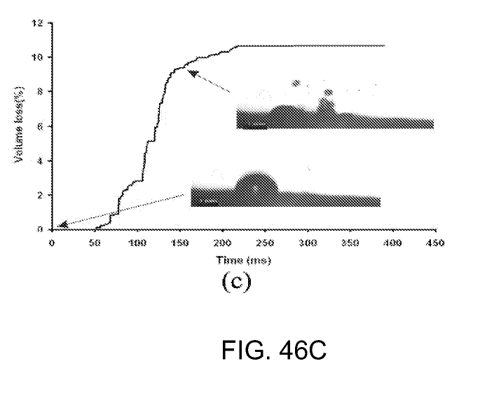

The results for the cooling rate j reported in Table 6 are based on the directly measured values of the loss fraction p evaluated from a careful analysis of the “atomization” during boiling using multiple video images similar to several frames depicted in FIGS. 43-46. The latter figures also contain the measured values of p during the whole process and the final plateau value. For the copper-plated mats the largest value of p does not exceed 0.1, i.e. is less than 10% (FIG. 43). For the bare copper substrate mass losses during boiling are quite dramatic, with p being of the order of 0.3 (FIG. 44), which means that about 30% of the initial drop was “atomized” and lost. For the silver-plated nanofibers p is about 0.03 (relatively low losses, FIG. 45), however, for the nickel-plated fibers losses might be as high as 20% (FIG. 46). Note, that there was no water “atomization” and thus, no losses, when boiling took place in gold-plated nanofiber mats.

The results for the cooling rate presented in Table 7 are based on the measured values of p. The non-zero values of p in Table 7 led to lower values of j for copper-plated fibers listed there compared to the case in Table 6 (probably due to sample-to-sample variability). Still, these values are close to a tremendous value of 0.4 kW/cm². The experimental values of the evaporation time Δt of water drops inside metal-plated nanofiber mats were supported by theoretical estimates. The agreement between predicted and measured values supports the conclusion based on processing the experimental data that cooling rates in the range of 0.4-0.6 kW/cm² were achieved using example nanofiber mats.

TABLE 7
The evaporation times and cooling rates for different
metal-plated nanofiber mats and a bare copper substrate. For
the bare copper substrate the value of the spreading ratio used to
calculate the corresponding heat flux j was directly measured from
the top view images.

| Material | Temperature (° C.) | Δt (ms) | p | j (kW/cm²) |
|---|---|---|---|---|
| Bare copper | 125 | 264 | 0.27 | 0.256 |
| | 150 | N/A | N/A | N/A |
| | 200 | N/A | N/A | N/A |
| Copper nanofibers | 125 | 172.5 | 0.04 | 0.136 |
| | 150 | 53 | 0.11 | 0.392 |
| | 200 | 52 | 0.09 | 0.408 |
| Silver nanofibers | 125 | 170 | 0 | 0.138 |
| | 150 | 128.5 | 0.006 | 0.181 |
| | 200 | 55.5 | 0.03 | 0.407 |
| Nickel nanofibers | 125 | 355 | 0.074 | 0.061 |
| | 150 | 600 | 0.20 | 0.031 |
| | 200 | 388 | 0.10 | 0.054 |
| Gold nanofiber | 125 | 495 | 0 | 0.047 |
| | 150 | 633.5 | 0 | 0.037 |
| | 200 | 468 | 0 | 0.049 |

A new method of electroplating of electrospun nanofiber mats allowed the preparation of copper-, silver-, nickel-, and gold-plated mats. The copper- and silver-plated individual nanofibers revealed high surface roughnesses, which made them similar to thorny devil lizards and dendrites/cactuses, respectively. In addition, these nanofibers and their mats possess high thermal diffusivities.

The presence of the example nanofiber mats dramatically reduces water losses due to boiling-associated “atomization” (e.g., zero or several percent loss on copper-plated nanofiber mats on a copper substrate compared to about 30% on a bare copper substrate). Moreover, the presence of nanofiber mats completely eliminated drop bouncing characteristic of bare hot surfaces, i.e. suppressed the Leidenfrost effect. It was shown that nanofiber surface roughness plays a more significant role than its thermal diffusivity for the enhancement of drop evaporation rate, and thus the heat removal rate. As a result, with copper-plated nanofiber mats cooling rates close to 0.6 kW/cm² were demonstrated, which is an impressive value in comparison with the previously achieved values reported in the literature.

Nanofiber coverings according to example embodiments of the present invention may be used for covering any of various surfaces. Nonlimiting examples include microelectronic components, unmanned aerial and ground vehicles, packets with electronics, machining equipment, shaving equipment, server rooms, and many others. Further, example nanofiber coverings according to embodiments of the present invention may be employed in alternative environments, such as but not limited to use as tissue templates or filter media.

According to certain embodiments of the present invention, metalized nano-textured fiber mats are provided having a very rough surface on the nano-scale and high thermal diffusivity. The amount of surface roughness can be adjusted according to example methods of manufacturing the fiber mats. Preferred embodiment metalized nano-textured fiber mats can provide high values of heat removal, for instance up to 0.6 kW/cm² or even higher. Such high heat flux values are more than an order of magnitude higher than currently available ones. Nonlimiting uses of metalized nano-textured fiber mats include cooling of high-heat-flux micro- and opto-electronics, and cooling of micro components for robotic devices such as but not limited to Unmanned Aerial Vehicles (UAV) and Unmanned Ground Vehicles (UGV). Such cooling can assist further miniaturization of these and other devices.

While various embodiments of the present invention have been shown and described, it should be understood that other modifications, substitutions, and alternatives are apparent to one of ordinary skill in the art. Such modifications, substitutions, and alternatives can be made without departing from the spirit and scope of the invention, which should be determined from the appended claims.

Various features of the invention are set forth in the appended claims.

What is claimed is:

1. A device comprising:
a micro component having an external surface; and
a permeable nanofiber covering on at least a portion of the external surface of said micro component.

2. The device of claim 1, wherein said micro component comprises at least one of a microelectronic micro component, a radiological micro component, and an optoelectronic micro component.

3. The device of claim 1, wherein said nanofiber covering comprises a non-woven polymer nanofiber covering.

4. The device of claim 3, wherein said nanofiber covering comprises an electrospinnable polymer having a thermal stability within an operational temperature range of said micro component.

5. The device of claim 1, wherein the external surface of said micro component has a heat flux of at least 1 kW/cm².

6. The device of claim 1, wherein said nanofiber covering comprises a nanofiber mat.

7. The device of claim 1, wherein said nanofiber covering has a thickness of between about 100 and 200 microns, and has a porosity of at least about 90%.

8. The device of claim 1, wherein said permeable nanofiber covering further comprises a metal layer disposed on nanofibers of said permeable nanofiber covering.

9. The device of claim 8, wherein said metal layer increases a rougher surface of said permeable nanofiber covering.

10. The device of claim 8, wherein said metal layer comprises an electroplated metal taken from the group consisting of gold, silver, copper, and nickel.

11. The device of claim 8, wherein said metal layer provides a thorny surface on the nanofibers.

12. The device of claim 8, wherein said metal layer provides a cactus-like surface on the nanofibers.

13. The device of claim 8, wherein said metal layer provides a surface resembling dendrites on the nanofibers.

14. The device of claim 1, further comprising:
at least one liquid droplet disposed on or within said nanofiber covering.

15. A cooled micro component system, comprising:
a device according to claim 1; and
a droplet spray system for spraying liquid droplets onto the nanofiber covering to cool the micro component.

16. The system of claim 15, wherein said droplet spray system comprises:
a liquid source;
at least one liquid passage in fluid communication with said liquid source; and
a fluid pressure source in fluid communication with said liquid source and said at least one liquid passage.

17. The system of claim 16,
wherein said at least one liquid passage comprises a plurality of passages; and
wherein said droplet spray system further comprises a fluid distributor in fluid communication with said fluid pressure source and said plurality of passages.

18. The system of claim 16, further comprising:
a chamber housing said device in a chamber interior;
wherein said at least one liquid passage is in fluid communication with the chamber interior.

19. A cooled micro component system, comprising:
a device according to claim 8; and
a droplet spray system for spraying liquid droplets onto the nanofiber covering to cool the micro component.

20. A method for cooling a microelectronic, radiological, or optoelectronic micro component, the method comprising:
directing droplet spray onto a permeable nanofiber covering that covers at least a portion of the microelectronic, radiological, or optoelectronic micro component; and
controlling said step of directing to permit efficient spreading and evaporation of liquid permeating the nanofiber covering.

21. The method of claim 20, wherein the permeable nanofiber covering further comprises a metal layer disposed on nanofibers of the permeable nanofiber covering to provide a rougher surface of the permeable nanofiber covering on the nano-scale.

22. A method for cooling a micro component, the method comprising:
providing a permeable nanofiber covering from a nanofiber material;
covering a high heat flux surface of a micro component with the nanofiber covering;
directing a liquid droplet onto the nanofiber covering.

23. The method of claim 22, wherein said providing comprises:
providing a polymer; and
electrospinning a polymer onto a surface.

24. The method of claim 23, wherein said provided polymer is selected from the group consisting of PAN, PCL, PCL+CB, PMMA, and PU.

25. The method of claim 23, wherein said provided polymer covering comprises a nanofiber mat.

26. The method of claim 23, wherein said providing further comprises:
forming a metal layer on nanofibers of the permeable nanofiber covering.

27. The method of claim 26, wherein said forming a metal layer comprises:
sensitizing the permeable nanofiber covering to be conductive or semi-conductive;
electroplating the metal layer on the sensitized permeable nanofiber covering.

28. The method of claim 27, wherein the metal layer is taken from the group consisting of copper, gold, silver, and nickel.

29. The method of claim 22, wherein said directing a liquid droplet comprises:
directing droplet spray including the liquid droplet onto the nanofiber covering; and
controlling said directing to permit efficient spreading and evaporation of liquid permeating the nanofiber covering.

30. The method of claim 29, wherein said controlling comprises:
selectively operating a pressure source to direct the droplet spray.

31. A device comprising:
a micro component comprising at least one of a microelectronic micro component, an optoelectronic micro component, and a radiological micro component, said micro component having a high heat flux outer surface;
a permeable nanofiber material directly or indirectly covering at least part of the outer surface, said nanofiber material comprising an electrospun non-woven polymeric material having a melting point that is higher than an operational range of said micro component, said nanofiber material having a porosity of at least 90%, said nanofiber material providing a nanofiber covering;
at least one liquid droplet disposed on or in said nanofiber material, wherein the at least one liquid droplet is sprayed onto the nanofiber material;
said nanofiber material accepting said at least one liquid droplet, spreading said at least one liquid droplet; and
said nanofiber material permeating said nanofiber material to increase wetting of the at least a portion of the nanofiber material.

32. The device of claim 31, wherein said permeable nanofiber material further comprises an electroplated metal layer on nanofibers of said permeable nanofiber material.

33. A method for fabricating a metalized nano-textured fiber mat comprising:
providing a nanofiber mat comprising non-woven nanofibers;
sensitizing the provided nanofiber mat to be conductive or semi-conductive; and
electroplating a metal layer on the non-woven nanofibers.

34. The method of claim 33, wherein said providing a nanofiber mat comprises:
providing a polymer solution; and
electrospinning the polymer solution onto a surface.

35. The method of claim 34, wherein said electroplating comprises:
providing an electroplating solution of a selected metal;
immersing the sensitized nanofiber mat in the provided electroplating solution; and
electroplating the immersed nanofiber mat.

36. The method of claim 35, wherein said sensitizing comprises sputter-coating the provided nanofiber mat with a conductive material.

37. The method of claim 35, further comprising:
removing the electroplating solution.

38. The method of claim 35, further comprising:
shaping the mat after said electroplating.

39. The method of claim 35, wherein the selected metal is taken from the group consisting of gold, silver, copper, and nickel.
